(19) United States
(12) Patent Application Publication
(10) Pub. No.: US 2004/0086774 A1
(43) Pub. Date: May 6, 2004

(54) Gas diffusion electrodes

(76) Inventors: Beth C. Munoz, Vista, CA (US); Gilbert J. Kepner, Oceanside, CA (US); Mark A. Preveti, San Diego, CA (US); Xiamoei Xi, Carlsbad, CA (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/288,392

(22) Filed: Nov. 5, 2002

(51) Int. Cl. H01M 4/86; H01M 4/88; H01M 4/96; H01M 4/90

(52) U.S. Cl. 429/42; 429/44; 502/101; 252/511; 264/331.11

(57) ABSTRACT

Electrode compositions can be formed comprising a fibrillatable polymer, a particulate electrical conductor a surfactant and a liquid. Corresponding methods apply shear to fibrillate the polymer, in which the surfactant facilitates the processing such that the resulting electrodes have desirable properties. The shear can be applied in an extrusion process and/or calendering process. These improved processing approaches can be used to form large commercial electrodes with a high degree of thickness uniformity. In some embodiments, the electrode compositions comprise a fibrillatable polymer, a particulate electrical conductor and a non-carbon friction reducing agent within a gas permeable structure. Molding processes can be used for forming the electrodes.

### FIELD OF THE INVENTION

The invention relates to gas diffusion electrodes for use in electrochemical cells, such as fuel cells and batteries. In particular, the invention relates to gas diffusion electrodes suitable for electrodes, for example, within metal-gas electrochemical cells, such as oxygen or air cells, and especially for cathodes for metal-air cells.

### BACKGROUND OF THE INVENTION

Gas diffusion electrodes, i.e., gas permeable electrodes, are suitable for use in electrochemical cells that have gaseous reactants, for use in the cathode for the reduction of oxygen, bromine or hydrogen peroxide. The reduction of gaseous molecular oxygen can be an electrode reaction, for example, in metal-air/oxygen batteries, metal-air/oxygen fuel cells and hydrogen-oxygen fuel cells. Oxygen is generally conveniently supplied to these electrochemical cells in the form of air. Similarly, the oxidation of gaseous molecular hydrogen can be the anode reaction in hydrogen-oxygen fuel cells. Fuel cells differ from batteries in that the reactants for the anode and cathode can both be replenished without disassembling the cells.

The cathode in an electrochemical cell containing an alkaline electrolyte and involving oxygen reduction generally catalyzes the reduction of oxygen, which combines with water to form hydroxide ions. The reduction of oxygen removes electrons at the cathode. The oxidation reaction at the anode gives rise to the electrons that flow to the cathode when the circuit connecting the anode and the cathode is closed. The electrons flowing through the closed circuit enable the foregoing oxygen reduction reaction at the cathode and simultaneously can enable the performance of useful work due to an over-voltage between the cathode and anode. For example, in one embodiment of a fuel cell employing metal, such as zinc, iron, lithium and/or aluminum, as a fuel and potassium hydroxide as an electrolyte, the oxidation of the metal to form an oxide or a hydroxide releases electrons. In some systems, a plurality of cells is coupled in series, which may or may not be within a single fuel cell unit, to provide a desired voltage. For commercially viable fuel cells, it is desirable to have electrodes that can function within desirable parameters for extended period of time on the order of 1000 hours or even more.

Fuel cells are a particularly attractive power supply because they can be efficient, environmentally safe and completely renewable. Metal/air fuel cells can be used for both stationary and mobile applications, such as all types of electric vehicles. Fuel cells offer advantages over internal combustion engines, such as zero emissions, lower maintenance costs, and higher specific energies. Higher specific energies can result in weight reductions. In addition, fuel cells can give vehicle designers additional flexibility to distribute weight for optimizing vehicle dynamics.

### SUMMARY OF THE INVENTION

In a first aspect, the invention pertains to an electrode composition comprising a fibrillatable polymer, a particulate electrical conductor, a surfactant and a liquid. Generally, the surfactant is soluble in the liquid.

In a further aspect, the invention pertains to a method for forming an electrode. The method comprises calendering an electrode composition comprising a fibrillatable polymer, a particulate electrical conductor, a liquid and a surfactant to form an electrode sheet.

In another aspect, the invention pertains to a gas permeable electrode film comprising a fibrillatable polymer and at least about 20 weight percent electrically conductive particles. The film has a width of at least about 6 centimeters and a thickness less than about 5 mm and a uniformity of thickness over the width of the film that varies by less than about 20% from the average.

Furthermore, the invention pertains to a gas permeable electrode comprising a fibrillatable polymer, a particulate electrical conductor, and a non-carbon friction reducing agent within a gas permeable structure.

In addition, the invention pertains to a method for forming an electrode. The method comprises molding an electrode composition within a mold. The electrode composition comprises a polymer, electrically conductive particulates, a carrier fluid and a pore forming agent.

### BRIEF DESCRIPTION OF THE DRAWINGS

FIG. 1 is a block diagram of a fuel cell.

FIG. 2 is a schematic diagram of a metal-air fuel cell designed for the continuous replenishment of metal fuel, in which a sectional side view of an anode is shown in phantom lines.

FIG. 3 is a sectional view of the fuel cell of FIG. 2 showing a cathode, in which the section is taken along line 3-3 of FIG. 2.

FIG. 4 is a sectional side view of an electrode assembly with a current collector embedded within an electrode.

FIG. 5 is a sectional side view of an electrode assembly with a current collector embedded within the surface of an electrode.

FIG. 6 is a sectional side view of an electrode assembly with a current collector attached to an electrode at its surface.

FIG. 7 is a sectional side view of an electrode assembly with a current collector embedded within one layer of an electrode assembly comprising an electrode backing layer and an active electrode layer.

FIG. 8 is a sectional side view of an electrode assembly with a current collector embedded between layers of an electrode assembly comprising an electrode backing layer and an active electrode layer.

FIG. 9 is a sectional side view of an electrode assembly with a current collector embedded within the surface of one layer of an electrode assembly comprising an electrode backing layer and an active electrode layer, in which the current collector is embedded adjacent the interface between the layers.

FIG. 10 is a sectional side view of an electrode assembly with a current collector embedded within the surface of one layer of an electrode assembly comprising an electrode backing layer and an active electrode layer, in which the current collector is embedded in the surface opposite the interface between the layers.

FIG. 11 is a sectional side view of an electrode assembly with a current collector attached along the free surface of one layer of an electrode assembly comprising an electrode backing layer and an active electrode layer.

FIG. 12 is a scanning electron micrograph of a cathode material prepared as described in Example 1.

FIG. 13 is a scanning electron micrograph of a cathode material prepared as described in Example 2.

FIG. 14 is a scanning electron micrograph of a cathode material prepared as described in Example 5.

FIG. 15 is a scanning electron micrograph of an active layer of a cathode material prepared as described in Example 5.

FIG. 16 is a scanning electron micrograph of a cross section of the backing layer of Example 5.

FIG. 17 is a plot of thermogravimetric measurements confirming that a surfactant is removed during a heating process.

### DETAILED DESCRIPTION OF THE INVENTION

Improved processing approaches can be used for the production of gas diffusion electrodes for batteries and/or fuel cells, such as commercial scale batteries and/or fuel cells. In some embodiments, an electrode composition is formed that comprises a fibrillatable polymer, a particulate electrical conductor, a surfactant and a liquid. The surfactant may facilitate the interaction of the fibrillatable polymer and the particulate electrical conductor, especially with aqueous processing liquids. In some embodiments, the fibrillatable polymer comprises a fluorinated polymer, such as polytetrafluoroethylene. The electrode composition can further comprise a friction reducing agent. The friction reducing agent is particularly useful in the formation of commercial scale electrodes having large dimension with a suitable uniformity.

The processing generally comprises forming the electrode composition into a sheet or the like for use as an electrode. At least a portion of the liquid can be removed from the formed electrode to increase the porosity, especially with respect to gas diffusion. The resulting gas diffusion electrode can be useful, for example, in electrochemical cells. The gas diffusion electrode can comprise a catalyst, or alternatively, the electrode can form an electrode backing layer lacking a catalyst, which can be combined with a catalyst structure to form a cathode assembly. The cathode assembly generally further comprises a current collector formed by a porous metal structure. In particular, the gas diffusion electrodes are suitable for use in batteries and fuel cells having a gaseous reactant, such as hydrogen-oxygen fuel cells and metal-air/oxygen fuel cells. The gas diffusion electrodes are particularly suitable for use as cathodes in zinc-air/oxygen fuel cells.

The gas diffusion electrodes are porous to gases such that gases can penetrate the electrode and/or gases can penetrate to catalyst particles within the electrode for reaction. In general, suitable polymers are fibrillatable in the sense that the polymers form a fibrous network usually upon the application of sufficient shear forces. The resulting structure is porous. The particulates, e.g., conductive particles and/or catalyst particles, are dispersed within the fibrous network. Although, in alternative embodiments, molding, such as compression molding, is performed in which the polymers are not necessarily fibrillatable. In these embodiments, porosity is introduced using a pore-forming agent.

The gas diffusion electrodes described herein are suitable for any uses for gas permeable electrodes. For example, the gas permeable electrodes are suitable as electrodes in batteries and fuel cells having a gaseous reactant, such as hydrogen, oxygen, bromine and/or peroxide. For example, hydrogen, metal or other fuel can be oxidized at the anode. The electrodes described herein are suitable for catalyzing the oxidation of gaseous hydrogen at the anode. A metal fuel cell is a fuel cell that uses a metal, such as zinc particles, as fuel. In a metal fuel cell, the fuel is generally stored, transmitted and used in the presence of a reaction medium, such as potassium hydroxide solution. Specifically, in metal-air batteries and metal-air fuel cells, oxygen is reduced at the cathode, and metal is oxidized at the anode. In some embodiments, oxygen is supplied as air. For convenience, air and oxygen are used interchangeably throughout unless a specific context requires a more specific interpretation. The gas diffusion electrodes described herein are suitable for catalyzing the reduction of oxygen at a cathode in fuel cell or battery. A fuel cell differs from a battery in that the fuel can be replenished within a fuel cell.

Electrode compositions refer to chemical compositions that are used in forming electrodes and not just the final composition of the electrode. Thus, liquids and other compounds that are subsequently removed in forming the final electrodes can be considered within an electrode composition that is eventually processed into the electrode. Thus, electrode compositions additional processing components beyond the compositions included within the final electrode structure. In general, electrode compositions comprise a polymer and an electrical conductor. The electrode composition can further include a catalyst or a reduction-oxidation active composition. The electrode composition can further comprise processing aids, fillers and the like.

For the production of certain commercial electrochemical cells, it is desirable to form electrodes with relatively large widths such that the resulting cells have a high total capacity. However, the processing of large electrodes posses particular processing issues. It has been found that processing of the electrode composition with additives can facilitate the processing of electrodes from fibrillatable polymers. Specifically, the electrode composition can comprise a surfactant and/or a friction reducing agent.

The electrode composition generally comprises electrically conductive particles in a fibrillatable polymer. The electrode composition can further comprise a catalyst. For processing, the electrode composition generally comprises a liquid. In some embodiments, the liquid is an aqueous liquid, such as water. If a surfactant is used, the surfactant generally is soluble in the liquid. Some or all of the liquid is ultimately removed to leave a porous structure that is at least gas permeable.

In general, suitable polymers for the electrode composition can be homopolymers, copolymers, block copolymers, polymer blends and mixtures thereof, as described further below. In embodiments based on fibrillatable polymers, suitable polymers include, for example, fluorinated polymers and blends and mixtures thereof. In embodiments involving molding, pore formers are agents that are compatible with the polymer in the sense that the pore former can be dispersed through the polymers mass and co-molded with the polymer. The pore former or a portion thereof is then removed to leave behind pores or voids in the locations at which the pore formers were located. In all of the embodiments, the particular components in the compositions and the processing conditions can be selected to yield particularly desired characteristics for the resulting electrode materials.

To form the electrode compositions, electrically conductive particles are included to provide the electrical conductivity. Generally, reasonably high loading levels can be used to obtain desired levels of electrical conductivity, as described further below. For gaseous reactants, catalysts can be included within the electrode material to catalyze the reaction of the gaseous reactants. The hydrophobicity of the electrode composition can be controlled to correspondingly control the amount of wetting of the electrode by the electrolyte. In addition, the electrode composition can be used in forming an electrode backing layer, which in some embodiments may itself be considered an electrode if it is electrically conductive. The electrode backing layer can be placed in adjacent an electrode with a catalyst. The electrode backing layer generally is electrically conductive and gas permeable. However, the electrode backing layer generally is more hydrophobic such that the electrolyte/reaction medium does not penetrate past the electrode active layer. Thus, the electrode backing layer can form a barrier to electrolyte loss through evaporation and/or flow from the cell.

In embodiments involving fibrillatable polymers, processing aids of particular interest include, for example, liquids/lubricants, surfactants and friction reducing agents or a lubricant additive. In general, a lubricant is a substance that reduces friction between parts of objects in relative motion. A lubricant additive generally is a composition added to lubricants to provide a special property, such as resistance to extremes of pressure, cold or heat, improved viscosity and/or detergency. Surfactants assist with the formation of a well-dispersed blend of the electrically conductive particles around the polymer particles/fibers, especially with aqueous and other polar liquids/lubricants. Thus, surfactants lead to surprisingly improved electrode properties for processing approaches based on aqueous liquids. The surfactants may or may not be present in the final electrodes since the surfactants may be removed in some of the later processing steps, such as drying or laminating the electrode. The friction reducing agents can also be referred to anti-wear agents or extreme pressure agents. A friction reducing agent(s) can also assist with the formation of arbitrarily sized electrodes of high uniformity. While the electrode generally does not move in use, the electrode composition is manipulated during the formation process. These manipulations are facilitated by the presence of one or more friction reducing agents and/or extreme pressure agents. For example, for the formation of large electrodes, the friction reducing agents reduce edge effects and other variations in uniformity across the extent of the electrode such that a more structurally uniform electrode results.

In some embodiments, the electrode composition is combined with a current collector to form an electrode assembly. The current collector generally is a highly electrically conductive porous network, which can be formed from a metal. The electrode assembly can further include an electrode backing layer and/or a separator.

While the electrodes can be used in batteries, fuel cells and other electrode applications, fuel cells are of particular interest. Thus, the discussion below focuses on fuel cells. However, a person of ordinary skill in the art can generalize the discussion for the use of the electrodes in other applications. In particular, air-based batteries, such as zinc-air batteries, are well known in the art and are described, for example, in U.S. Pat. No. 3,881,959, entitled “Air Cell,” U.S. Pat. No. 3,746,580, entitled “Gas Depolarizable Galvanic Cell,” and U.S. Pat. No. 5,366,822, entitled “cell For a Metal-Air Battery,” which are all three incorporated herein by reference. In particular, the electrodes described herein can be incorporated into the metal-air batteries based on the disclosure herein.

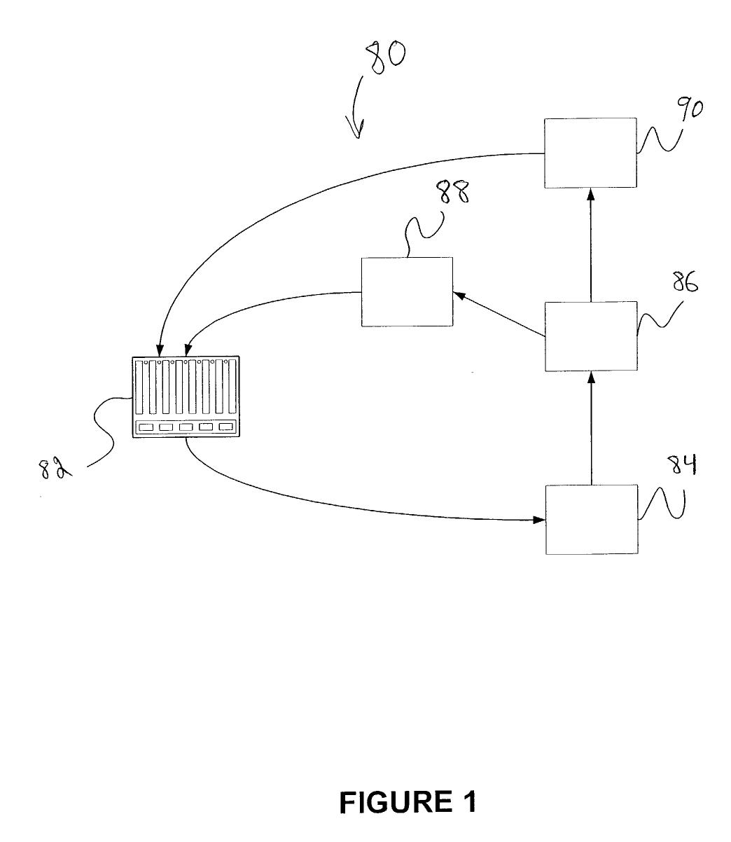

A block diagram of a fuel cell system 80 is illustrated in FIG. 1. As illustrated, the fuel cell system comprises a power source 82, an optional reaction product storage unit 84, an optional regeneration unit 86, a fuel storage unit 88, and an optional second reactant storage unit 90. The power source 82 in turn comprises one or more fuel cell units each having a cell body defining a cell cavity, with an anode and cathode situated in each cell cavity. The fuel cell units can be coupled in parallel or series, or independently coupled to different electrical loads. Similarly, multiple electrodes within each fuel cell unit can be coupled in series or in parallel to provide either additional voltage (series connection) or additional amperage (parallel connection). In one implementation, they are coupled in series.

The anodes within the cell cavities in power source 82 comprise the equivalent fuel stored in fuel storage unit 88. Exemplary fuel storage units include without limitation one or more of any of the enumerated types of reaction product storage units, which in one embodiment are made of a substantially non-reactive material (e.g., stainless steel, plastic, or the like), for holding potassium hydroxide (KOH) and metal (e.g., zinc (Zn), other metals, and the like) particles, separately or together, and the like, and suitable combinations of any two or more thereof Within the cell cavities of power source 82, an electrochemical reaction takes place whereby the anode releases electrons, and forms one or more reaction products. Through this process, the anodes are gradually consumed.

The electrons released from the electrochemical reaction at the anode flow through a load to the cathode, where they react with one or more second reactants from an optional second reactant storage unit 90 or from some other source. This flow of electrons is available to drive the demanded current, which through the load, gives rise to an over-potential (i.e., work). The over-potential acts to decrease the theoretical voltage between the anode and the cathode such that the over-potential can be used as work rather than being wasted as heat. This theoretical voltage arises due to the difference in electrochemical potential between the anode (for example, in the case of a zinc fuel cell, Zn potential of −1.215V versus SHE (standard hydrogen electrode) reference at open circuit) and cathode (O₂ potential of +0.401V versus SHE reference at open circuit). When the cells are combined in series, the sum of the voltages for the cells forms the output of the power source.

The one or more reaction products can then be provided to optional reaction product storage unit 84 or to some other destination. Exemplary reaction product storage units include without limitation one or more tanks, one or more sponges, one or more containers, one or more vats, one or more canister, one or more chambers, one or more cylinders, one or more cavities, one or more barrels, one or more vessels, and the like, including without limitation those found in or which may be formed in a substrate, and suitable combinations of any two or more thereof. The one or more reaction products, from unit 84 or some other source, can then be provided to optional regeneration unit 86, which regenerates fuel and/or one or more of the second reactants from the one or more reaction products. The regenerated fuel can then be provided to fuel storage unit 88, and/or the regenerated one or more second reactants can then be provided to optional second reactant storage unit 90 or to some other destination. As an alternative to regenerating the fuel from the reaction product using the optional regeneration unit 86, the fuel can be inserted into the system from an external source and the reaction product can be withdrawn from the system.

The optional reaction product storage unit 84 comprises a unit that can store the reaction product. Optionally, the optional reaction product storage unit 84 is detachably attached to the system. The optional regeneration unit 86 comprises a unit that can electrolyze the reaction product(s) back into fuel (e.g., electroactive particles, including without limitation metal particles and/or metal-coated particles, electroactive electrodes, and the like, and suitable combinations of any two or more thereof) and/or second reactant (e.g., air, oxygen, hydrogen peroxide, other oxidizing agents, and the like, and suitable combinations of any two or more thereof). The power source 82 can optionally function as the optional regeneration unit 86 by operating in reverse, thereby foregoing the need for a regeneration unit 86 separate from the power source 82. Optionally, the optional regeneration unit 86 is detachably attached to the system. Exemplary regeneration units include without limitation metal (e.g., zinc) electrolyzers (which regenerate a fuel (e.g., zinc) and a second reactant (e.g., oxygen) by electrolyzing a reaction product (e.g., zinc oxide (ZnO)), and the like. Exemplary metal electrolyzers include without limitation fluidized bed electrolyzers, spouted bed electrolyzers, and the like, and suitable combinations of two or more thereof.

The fuel storage unit 88 comprises a unit that can store the fuel (e.g., for metal fuel cells, electroactive particles, including without limitation metal (or metal-coated) particles, liquid born metal (or metal-coated) particles, and the like; electroactive-electrodes, and the like, and suitable combinations of any two or more thereof). Optionally, the fuel storage unit 88 is detachably attached to the system. The optional second reactant storage unit 90 comprises a unit that can store the second reactant. Exemplary second reactant storage units include without limitation one or more tanks (for example, without limitation, a high-pressure tank for gaseous second reactant (e.g., oxygen gas), a cryogenic tank for liquid second reactant (e.g., liquid oxygen) which is a gas at operating temperature (e.g., room temperature), a tank for a second reactant which is a liquid or solid at operating temperature (e.g., room temperature), and the like), one or more of any of the enumerated types of reaction product storage units, which in one embodiment are made of a substantially non-reactive material, and the like, and suitable combinations of any two or more thereof. Optionally, the optional second reactant storage unit 90 is detachably attached to the system. Thus, in some embodiments, power source 82 can be disconnected from the other components of fuel cell system 80.

In some embodiments, the fuel cell is a metal fuel cell. The fuel of a metal fuel cell is a metal that can be in a form to facilitate entry into the cell cavities of the power source 82. For example, the fuel can be in the form of metal (or metal-coated) particles or liquid born metal (or metal-coated) particles or suitable combinations of any two or more thereof. Exemplary metals for the metal (or metal-coated) particles include without limitation zinc, aluminum, lithium, magnesium, iron, sodium, and the like. Suitable alloys of such metals can also be utilized for the metal (or metal-coated) particles.

In this embodiment, when the fuel is optionally already present in the anode of the cell cavities in power source 82 prior to activating the fuel cell, the fuel cell is pre-charged, and can start-up significantly faster than when there is no fuel in the cell cavities and/or can run for a time in the range(s) from about 0.001 minutes to about 1000 minutes without additional fuel being moved into the cell cavities. The amount of time in which the fuel cell can run on a pre-charge of fuel within the cell cavities can vary with, among other factors, the pressurization of the fuel within the cell cavities, and the power drawn from the fuel cell, and alternative embodiments of this aspect of the invention permit such amount of time to be in the range(s) from about 1 second to about 1000 minutes or more, and in the range(s) from about 30 seconds to about 1000 minutes or more.

Moreover, the second reactant optionally can be present in the fuel cell. Specifically, for fuel cells with cathodes involving gaseous reactants, the cell can be pre-pressurized to any pressure in the range(s) from about 0 psi gauge pressure to about 200 psi gauge pressure. Furthermore, in this embodiment, one optional aspect provides that the volumes of one or both of the fuel storage unit 88 and the optional second reactant storage unit 90 can be independently changed as required to independently vary the energy of the system from its power, in view of the requirements of the system. Suitable such volumes can be calculated by utilizing, among other factors, the energy density of the system, the energy requirements of the one or more loads of the system, and the time requirements for the one or more loads of the system. In one embodiment, these volumes can vary in the range(s) from about 10⁻¹² liters to about 1,000,000 liters. In another embodiment, the volumes can vary in the range(s) from about 10⁻¹² liters to about 10 liters. A person of ordinary skill in the art will recognize that additional ranges of the fuel cell parameters are contemplated and are within the present disclosure.

In one aspect of this embodiment, at least one of, and optionally all of, the metal fuel cell(s) is a zinc fuel cell in which the fuel is in the form of fluid borne zinc particles immersed in a potassium hydroxide (KOH) electrolytic reaction solution, and the anodes within the cell cavities are particulate anodes formed of the zinc particles. In this embodiment, the reaction products can be the zincate ion, Zn(OH)₄²⁻, or zinc oxide, ZnO, and the one or more second reactants can be an oxidant (for example, oxygen (taken alone, or in any organic or aqueous (e.g., water-containing) fluid (for example and without limitation, liquid or gas (e.g., air)), hydrogen peroxide, and the like, and suitable combinations of any two or more thereof). When the second reactant is oxygen, the oxygen can be provided from the ambient air (in which case the optional second reactant storage unit 90 can be excluded), or from the second reactant storage unit 90. Similarly, when the second reactant is oxygen in water, the water can be provided from the second reactant storage unit 90, or from some other source, e.g., tap water (in which case the optional second reactant storage unit 90 can be excluded). In order to replenish the cathode, to deliver second reactant(s) to the cathodic area, and to facilitate ion exchange between the anodes and cathodes, a flow of the second reactant(s) can be maintained through a portion of the cells. This flow optionally can be maintained through one or more pumps (not shown in FIG. 1), blowers or the like, or through some other means. If the second reactant is air, it optionally can be pre-processed to remove CO₂ by, for example, passing the air through soda lime. This is generally known to improve performance of the fuel cell.

In this embodiment, the particulate fuel of the anodes is gradually consumed through electrochemical dissolution. In order to replenish the anodes, to deliver KOH to the anodes, and to facilitate ion exchange between the anodes and cathodes, a recirculating flow of the fluid borne zinc particles can be maintained through the cell cavities. This flow can be maintained through one or more pumps (not shown), convection, flow from a pressurized source, or through some other means.

As the potassium hydroxide contacts the zinc anodes, the following reaction takes place at the anodes:

Zn+4OH⁻→Zn(OH)₄²⁻+2e⁻ (1)

The two released electrons flow through a load to the cathode where the following reaction takes place:

$$\frac{1}{2} {O}_{2} + 2 {e}^{-} + {H}_{2} O \to 2 {OH}^{-} \qquad ( 2 )$$

The reaction product is the zincate ion, Zn(OH)₄²⁻, which is soluble in the reaction solution KOH. The overall reaction which occurs in the cell cavities is the combination of the two reactions (1) and (2). This combined reaction can be expressed as follows:

$$Zn + 2 {OH}^{-} + \frac{1}{2} {O}_{2} + {H}_{2} O \to {Zn ( OH )}_{4}^{2 -} \qquad ( 3 )$$

Alternatively, the zincate ion, Zn(OH)₄²⁻, can be allowed to precipitate to zinc oxide, ZnO, a second reaction product, in accordance with the following reaction:

Zn(OH)₄^{2-→ZnO+H}₂O+1OH⁻ (4)

In this case, the overall reaction which occurs in the cell cavities is the combination of the three reactions (1), (2), and (4). This overall reaction can be expressed as follows:

$$Zn + \frac{1}{2} {O}_{2} \to ZnO \qquad ( 5 )$$

Under ambient conditions, the reactions (4) or (5) yield an open-circuit voltage potential of about 1.4V. For additional information on this embodiment of a zinc/air battery or fuel cell, the reader is referred to U.S. Pat. Nos. 5,952,117; 6,153,329; and 6,162,555, which are hereby incorporated by reference herein as though set forth in full.

The reaction product Zn(OH)₄²⁻, and also possibly ZnO, can be provided to reaction product storage unit 84. Optional regeneration unit 86 can then reprocess these reaction products to yield oxygen, which can be released to the ambient air or stored in second reactant storage unit 90, and zinc particles, which are provided to fuel storage unit 88. In addition, the optional regeneration unit 86 can yield water, which can be discharged through a drain or stored in second reactant storage unit 90 or fuel storage unit 88. It can also regenerate hydroxide, OH⁻, which can be discharged or combined with potassium ions to yield the potassium hydroxide reaction solution.

The regeneration of the zincate ion, Zn(OH)₄²⁻, into zinc, and one or more second reactants can occur according to the following overall reaction:

$${Zn ( OH )}_{4}^{2 -} \to Zn + 2 {OH}^{-} + {H}_{2} O + \frac{1}{2} {O}_{2} \qquad ( 6 )$$

The regeneration of zinc oxide, ZnO, into zinc, and one or more second reactants can occur according to the following overall reaction:

$$ZnO \to Zn + \frac{1}{2} {O}_{2} \qquad ( 7 )$$

It should be appreciated that embodiments of metal fuel cells other than zinc fuel cells or the particular form of zinc fuel cell described above are possible for use in a system according to the invention. For example, aluminum fuel cells, lithium fuel cells, magnesium fuel cells, iron fuel cells, sodium fuel cells, and the like are possible.

In addition, metal fuel cells are contemplated where the fuel is not in particulate form but in another form such as without limitation sheets, ribbons, strings, slabs, plates, or the like, or suitable combinations of any two or more thereof Embodiments are also possible in which the fuel is not fluid borne or continuously re-circulated through the cell cavities (e.g., porous plates of fuel, ribbons of fuel being cycled past a reaction zone, and the like). It is also possible to avoid an electrolytic reaction solution altogether or at least employ reaction solutions comprising elements other than potassium hydroxide, for example, without limitation, reaction solutions comprising sodium hydroxide, inorganic alkalis, alkali or alkaline earth metal hydroxides or aqueous salts such as sodium chloride, or the like, or suitable combinations of any two or more thereof. See, for example, U.S. Pat. No. 5,958,210, the entire contents of which are incorporated herein by this reference. It is also possible to employ metal fuel cells that output AC power rather than DC power using an inverter, a voltage converter, or the like, or suitable combinations of any two or more thereof.

In some embodiments of a fuel cell, a metal fuel cell system is provided that is characterized in that it has one, or any suitable combination of two or more, of the following properties: the system optionally can be configured to not utilize or produce significant quantities of flammable fuel or product, respectively; the system can provide primary and/or auxiliary/backup power to the one or more loads for an amount of time limited only by the amount of fuel present (e.g., in the range(s) from about 0.01 hours to about 10,000 hours or more, and in the range(s) from about 0.5 hours to about 650 hours, or more); the system optionally can be configured to have an energy density in the range(s) from about 35 Watt-hours per kilogram of combined fuel and electrolyte (reaction medium) added to about 400 Watt-hours per kilogram of combined fuel and electrolyte added; the system optionally can further comprise an energy requirement and can be configured such that the combined volume of fuel and electrolyte added to the system is in the range(s) from about 0.0028 L per Watt-hour of the system's energy requirement to about 0.025 L per Watt-hour of the system's energy requirement, and this energy requirement can be calculated in view of, among other factors, the energy requirement(s) of the one or more load(s) comprising the system (In one embodiment, the energy requirement of the system can be in the range(s) from 50 Watt-hours to about 500,000 Watt-hours, whereas in another embodiment, the energy requirement of the system can be in the range(s) from 5 Watt-hours to about 50,000,000 Watt-hours; in yet another embodiment, the energy requirement can range from 5×10⁻¹² Watt-hours to 50,000 Watt-hours); the system optionally can be configured to have a fuel storage unit that can store fuel at an internal pressure in the range(s) from about −5 pounds per square inch (psi) gauge pressure to about 200 psi gauge pressure; the system optionally can be configured to operate normally while generating noise in the range(s) from about 1 dB to about 50 dB (when measured at a distance of about 10 meters there from), and alternatively in the range(s) of less than about 50 dB (when measured at distance of about 10 meters there from). In one implementation, this metal fuel cell system comprises a zinc fuel cell system.

An advantage of fuel cells relative to traditional power sources such as lead acid batteries is that they can provide longer term primary and/or auxiliary/backup power more efficiently and compactly. This advantage stems from the ability to continuously refuel the fuel cells using fuel stored with the fuel cell, from some other source, and/or regenerated from reaction products by the optional regeneration unit 86. In the case of the metal (e.g., zinc) fuel cell, for example, the duration of time over which energy can be provided is limited only by the amount of fuel and reaction medium (if used) which is initially provided in the fuel storage unit, which is fed into the system during replacement of a fuel storage unit 88, and/or which can be regenerated from the reaction products that are produced. Thus, the system, comprising at least one fuel cell that comprises an optional regeneration unit 86 and/or a replaceable fuel storage unit 88, can provide primary and/or auxiliary/backup power to the one or more loads for a time in the range(s) from about 0.01 hours to about 10000 hours, or even more. In one aspect of this embodiment, the system can provide back-up power to the one or more loads for a time in the range(s) from about 0.5 hours to about 650 hours, or even more. Moreover, the system can optionally can be configured to expel substantially no reaction product(s) outside of the system (e.g., into the environment).

For the processing of the electrode composition, the desired components are generally blended together initially to form a paste. In embodiments of particular interest, the paste comprises a liquid processing aid. Generally, the paste has a high viscosity such that an appropriate mixer is used with a high shear capability. Thus, the electrode composition with a liquid generally is blended to form a well-mixed blend of components.

The mixture generally then is formed into a sheet. For compression molding, the pore forming agent should be selected such that the liquid pore former does not phase separate from the polymer and remains well dispersed within the polymer. For fibrillatable polymers, the materials can be processed with the application of shear that results in the formation of fibers from the polymer. The resulting fiber network maintains the structural integrity of the material and forms the porous structure for gas diffusion and, optionally, wetting by an electrolyte.

Generally, for fibrillatable polymers, the shear is applied through calendering of the electrode composition. In some embodiments, the initial formation of a sheet and/or application of shear can be performed by extrusion, for example, ram extrusion. For commercial scale production, extrusion is an appropriate initial step for forming a sheet of the composition since the extrusion can be performed at reasonable rates without excessive amounts of human intervention. Specifically, extrusion generally can be performed to yield good uniformity with little handling of the materials by personnel.

Calendering generally both shapes the material and applies shear to fibrillate or further fibrillate the polymer. Calendering comprises passing the polymer through a gap with a restricted dimension. The gap can be formed by rollers and/or belts. With respect to shaping, calendering generally involves a thinning of the sheet structure to obtain a final thickness as desired. A natural consequence of the thinning process is an expansion of the area of the sheet. Typically, the expansion is uniaxial along the machine direction (i.e., the direction of the movement of the material) with little cross machine expansion. A plurality of calendering steps can be performed to gradually reduce the thickness of the sheet. With respect to the application of shear, the shear is a natural result of passing the sheet through a gap with a dimension less than the initial thickness of the sheet. If extrusion is used, the extrusion itself can apply shear and provide a sheet with a particular thickness determined by the dimensions of the extrusion die. Thus, if extrusion is used, less calendering may be needed to obtain a desired level of fibrillation or to provide a sheet with a desired thickness. Generally, a desired level of fibrillation is needed to obtain a desired level of porosity and mechanical strength of the sheet.

To form an electrode assembly, the electrode composition generally is combined with a current collector and/or one or more additional electrode layers. Additional electrode layers can be, in particular, an electrode backing layer if the first electrode layer is an active layer or an active electrode layer if the first electrode layer is an electrode backing layer. Generally, an active electrode layer comprises a catalyst(s) to catalyze the reaction of a gaseous reactant. One or more of the active electrode layers, electrode backing layers and/or current collectors can be co-calendered. Similarly, an active electrode layer and an electrode backing layer can be co-extruded. In other embodiments, the elements of the electrode assembly are attached in appropriate steps, such as lamination. Thus, the thickness of an active electrode layer and/or an electrode backing layer can be reduced to a desired thickness prior to combining layers and/or after combining layers.

The electrode assembly can then be assembled into a cell. Formation of a cell generally involves assembly of two electrode assemblies to function as an anode and a cathode with a separator between the two electrode assemblies. A separator can be integral with one electrode assembly and can be positioned appropriately to separate the anode and cathode of a cell. The separator is an electrically insulating structure. Suitable commercial materials for formation of separators include, for example, Freudenberg FS-2224-R, a polypropylene non-woven cloth (Freudenberg Group of Companies), Freudenberg FS-2115, a polyamide non-woven cloth, Crane CC21.0, a polyethylene sulfide non-woven cloth, Hollingsworth & Vose BP5053-W, a polyethylene/polypropylene mixture non-woven cloth (Hollingsworth & Vose Company, East Warpole, Mass.), UCB Cellophane, a poly non-woven cellophane cloth (UCB Cellophane Ltd., UK); Celgard 3401, polypropylene with a surfactant microporous membrane (Celgard Inc., Charlotte, N.C.); and CN 20/20, an acrylate grafted polyethylene non-porous membrane.

In some embodiments, the structure and/or composition of the anode and cathode are different from each other. One or more cell structures can be placed within a housing along with an electrolyte. The current collectors are generally connected for parallel or series connection of the cells.

The electrode compositions described herein provide for facilitated processing for the formation of electrodes, especially electrodes with a large surface area. In particular, the presence of a surfactant during processing provides for the use of aqueous solvents and the like, which can have easier disposal and use requirements since they do not pose a risk of environmental contamination. Also, the use of a friction reducing agent facilitates the formation of high surface area electrodes with high uniformity, such as with respect to thickness uniformity across an electrode and a Gurley number within desirable ranges. The Gurley number is a measurement of the porosity of the material.

Metal-Air Fuel Cell

A metal-air fuel cell involves oxidation of metal at the cathode and reduction of oxygen at the anode. The metal can be replenished such that the cell can continue to function indefinitely. Thus, the fuel cell system comprises a metal delivery section that can be operably connected with the fuel cell. The fuel cell unit comprises at least one anode and cathode spaced apart with a separator, which are all in contact with an electrolyte. Generally, the fuel cell unit is in a housing that provides for appropriate air-flow, maintenance of the electrolyte, connection with the metal delivery section and electrical contact to provide electrical work.

A particular embodiment of a zinc-air fuel cell system 100 is shown in FIG. 2. The zinc-air fuel system 100 comprises a zinc fuel tank 102, a zinc-air fuel cell stack or power source 104, an electrolyte management unit 106, a piping system 108, one or more pumps 110, and one or more valves (not shown) that define a closed flow circuit for the circulation of zinc particles and electrolyte during fuel cell operation. The zinc fuel tank 102, the electrolyte management unit 106, or a combination of these and/or other system components, may be a separable, detachable part of the system 100.

Zinc pellets in a flow medium, such as concentrated potassium hydroxide (KOH) electrolyte solution are located in the zinc fuel tank 102. In another implementation, the particles can be a type of metal other than zinc, such as aluminum (aluminum-air fuel cell), lithium (lithium-air fuel cell), iron (iron-air fuel cell), or a particulate material other than metal that can act as an oxidant or reductant. In other embodiments, the flow medium is a fluid, e.g., liquid or gas, other than an electrolyte.

The zinc and electrolyte solution can be, for example, pulsed, intermittently fed, or continuously fed from the zinc fuel tank 102, through the piping system 108, and into an inlet manifold 112 of the cell stack 104. Piping system 108 can comprise one or more fluid connecting devices, e.g., tubes, conduits, elbows, and the like, for connecting the components of system 100.

Power source 104 comprises a stack of one or more bipolar cells 114, each generally defining a plane and coupled together in series. Five such cells are shown in FIG. 1 for illustrative purposes; however, the number of cells 114 in power source 104 can vary depending on the desired application of power source 104. Each cell 114 has an open circuit voltage determined by the reduction and oxidation reactants within the cell along with the cell structure, which can be expressed as M volts. Assuming that the open circuit potential of all the cells are equal, power source 104 has an open-circuit potential P equal to M volts x N cells, where N is the number of cells in power source 104.

Zinc-air fuel cell 114 interfaces with a fuel cell frame or body 136. The fuel cell body 136 generally forms a fuel cell cavity 137. Each cell 114 includes an air positive electrode or cathode 132 that occupies can entire surface or side of cell 114 and a zinc negative electrode or anode 134 that occupies an opposite entire side of cell 114. The cathode and anode are separated by an electrically insulating separator. A porous and electrically conductive film may be inserted between the electrodes 132, 134 of adjacent cells such that air can be blown through the film for supplying oxygen to each air positive electrode 132.

The bipolar stack 104 may be created by simply stacking cells 114 such that the current collector of negative electrode 134 of each cell is in physical contact with the positive electrode surface 132 of adjacent cell 114, with the porous and electrically conductive substance there between. With this structure, the resulting series connection provides a total open circuit potential between the first negative electrode 134 and the last positive electrode 132 of P volts. With these structures, extremely compact high voltage bipolar stacks 104 can be constructed. Furthermore, since no wires are used between cells 114 and since electrodes 132, 134 comprise large surface areas, the internal resistance between cells is extremely low.

The interface between one positive electrode 132 and piping system 108 through inlet manifold 112 is shown in phantom lines in FIG. 2. Inlet manifold 112 can run through cells 114 of power source 104, for example, perpendicular to the planes defined by the cells. Inlet manifold 112 distributes fluidized zinc pellets to cells 114 via conduits or cell filling tubes 116. Each inlet conduit 116 lies within its respective cell 114.

The zinc particulates and electrolyte flow through a flow path 115 in each cell 114, generally within the plane of the cell. The method of delivering particles to the cells 114 is a flow-through method. A dilute stream of pellets in flowing KOH electrolyte is delivered to the flow path 115 at the top of the cell 114 via conduit 116. The stream flows through flow path 115, across the zinc particle bed, and exits on the opposite side of cell 114 via outlet tube 118. Some of the pellets in the stream are directed by baffles 140 into electroactive zone 119. Pellets that remain in the flow stream are removed from cell 114. This flow through method, along with baffles 140, allows the electroactive zone 119 to occupy substantially all of the cell cavity and remain substantially constantly filled with zinc particles. As a result, the electrochemical potential of each cell 114 is maintained at desired levels per cell cavity volume. Pumps 110 can be used to control the flow rate of electrolyte and zinc through system 110. The fuel cell cavity communicates with inlet manifold 112 via cell filling tube 116.

As the zinc particles dissolve in electroactive zone 119 of cell 114, a soluble zinc reaction product, zincate, is produced. The zincate passes through a screen mesh or filter 122 near a bottom 123 of cell 114 and is washed out of the active area of cell 114 with electrolyte that also flows through cell 114 and filter 122. Screen mesh or filter 122 causes the electrolyte that exits cell 114 to have a negligible amount or no zinc particles. The flow of electrolyte through cell 114 not only removes the soluble zinc reaction product and, thereby, reduces precipitation of discharge products in the electrochemical zone 119, it also removes unwanted heat, helping to prevent cell 114 from overheating.

Electrolyte exits cell 114 and cell stack 104 via an electrolyte outlet conduit 128 and electrolyte manifold 130, respectively. The electrolyte is drawn into electrolyte management unit 106 through piping system 108. A pump (not shown) may be used to draw electrolyte into the electrolyte management unit 106. Electrolyte management unit 106 can be used to remove zincate and/or heat from the electrolyte so that the same electrolyte can be added to the zinc fuel tank 102 for zinc fluidation purposes. Electrolyte management unit 106, like zinc fuel tank 102, may be part of an integral assembly with the rest of system 100, or it maybe a separate, detachable part of system 100.

A constant supply of oxygen is required for the electrochemical reaction in each cell 114. To effectuate the flow of oxygen, one embodiment of system 100 can include a plurality of air blowers 124 and an air outlet 126 on the side of cell stack 104 to supply a flow of air comprising oxygen to the positive air electrodes/cathodes of each cell 114. A porous substrate such as a nickel foam may be disposed between each cell 114 to allow the air to reach the air cathode of each cell and to flow through the stack 104. In other embodiments, an oxidant other than air, such as pure oxygen, bromine or hydrogen peroxide, can be supplied to a cell 114 for the electrochemical reaction.

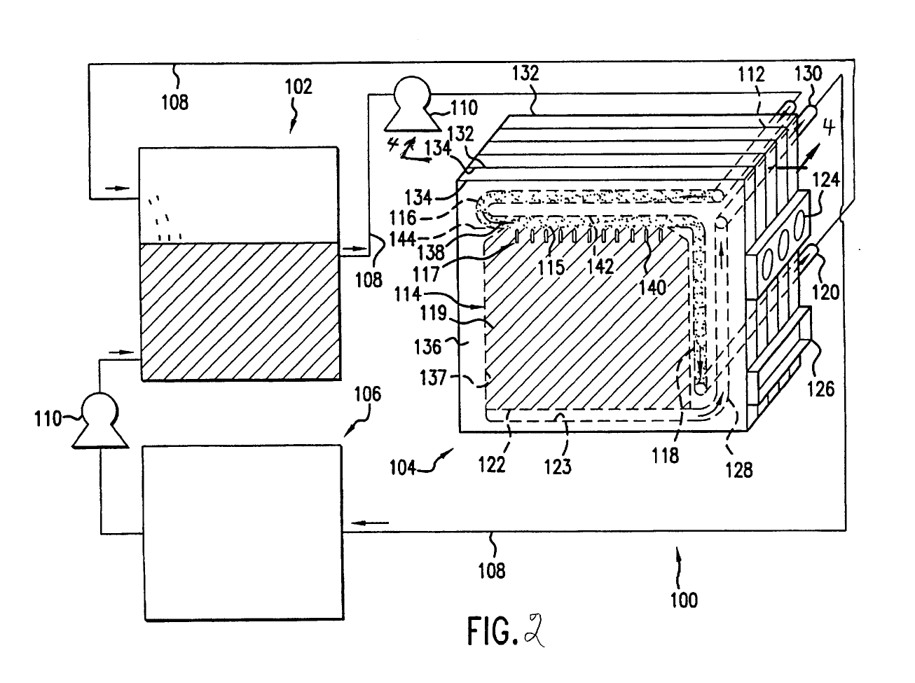

A sectional view of system 100 in FIG. 3 displays a positive air electrode/cathode 132 within one cell 114 of cell stack 104. Positive air electrode 132 is held with cell 114 within fuel cell frame 136. A non-porous divider 160 separates gas inflow from air blowers 124 from air outlets 126. Frame 136 forms an inlet chamber 162 and an outlet chamber 164. Inlet chamber 162 and outlet chamber 164, respectively, form passageways from positive air electrode 132 to air blowers 124 and air outlets 126. A gas permeable membrane 166 can be placed between air chambers 162, 164 and electrode 132 to reduce or prevent loss of electrolyte through flow out of the cell and/or evaporation.

The above detailed description is directed to one particular embodiment of a zinc-air fuel cell. A more general description of fuel cell construction is found above with respect to the block diagram in FIG. 1. Various other fuel cell designs can make effective use of the electrodes described herein. Metal-air fuel cells are described further in U.S. Pat. No. 6,296,958 to Pinto et al., entitled “Refuelable Electrochemical Power Source Capable Of Being Maintained In A Substantially Constant Fuel Condition And Method Of Using The Same,” and U.S. Pat. No. 5,952,117, entitled “Method And Apparatus For Refueling An Electrochemical Power Source,” both of which are incorporated herein by reference.

While certain configuration of the positive air electrode/cathode are suitable for use in the fuel cell of FIG. 2, a broader range of gas diffusion electrode structures are generally useful and are described further below.

Gas Diffusion Electrode Composition and Structure

The electrode composition for forming a gas diffusion electrode generally comprises a polymer and electrically conductive particles held together by the polymer as a binder. In some embodiments, the electrode composition can further comprise, for example, a liquid, a surfactant and/or a friction reducing agent, one or more of which can be removed or partly removed in forming the final electrode structure. The electrode composition can comprise catalyst(s) for the formation of an active electrode material. The electrode composition can further comprise additional materials to facilitate processing and/or to form a structure with desired properties. The electrode composition can be formed into an electrode assembly by combining the electrode composition with a current collector and/or additional electrode layers. The electrode composition typically is formed into a structure with a generally planar aspect with a thickness that is significantly smaller than the dimensions across the face of the planar structure.

The electrode composition can comprise a fluid phase and a solid phase. The fluid phase comprises a fluid and, optionally, compositions dissolved within the fluid. The solid phase includes everything not in the fluid phase. The fluid phase can be, for example, a liquid or a gas that diffuses out by applying suitable conditions, such as heat, or by dissolution of the fluid from the electrolyte. In some embodiments, the electrode composition comprises a weight ratio of fluid phase to solid phase in the range(s) of no more than about 20.0, in other embodiments in the range(s) of no more than about 10.0, and in further embodiments in the range(s) from about 9.0 to about 0.5 and in some embodiments in the range(s) from about 3.5 to about 1.5. A person of ordinary skill in the art will recognize that additional range(s) within these explicit ranges are contemplated and are within the present disclosure. Generally but not necessarily, the electrode composition has a greater ratio of fluid to solid during the mixing stages relative to other stages of the processing. In general, the ratio of fluid to solid components varies during the electrode processing. At the completion of the electrode preparation, the electrode may or may not be devoid of fluid. In some embodiments, the electrode following drying may have no more than about 5 weight percent liquid.

In some embodiments of interest, for the formation of an active layer, the solid phase of the electrode composition generally comprises in the range(s) from about 5 weight percent to about 50 weight percent of polymer and in further embodiments, in the range(s) from about 10 weight percent to about 35 weight percent. In additional embodiments, for the formation of an electrode backing layer, the solid phase of the cathode composition generally comprises in the range(s) from about 40 weight percent to about 90 weight percent polymer. A person of ordinary skill in the art will recognize that additional ranges within these explicit ranges are contemplated and are within the present disclosure. For the processing of the cathode material by calendering and/or extrusion, the polymer can be a fibrillatable polymer. Suitable fibrillatable polymers include, for example, polytetrafluoroethylene (e.g., Teflon®9B, 602A, 610A, 612A, 640, K-10, CFP6000, 60, 67, and NXT (DuPont), Halon™ and Algoflon™ (Ausimont USA), Fluon™ (ICI America Inc.), Hostaflon™ (Hoechst Celanese) and Polyflon™ (Daikan)), polyproplyene, polyethylene (generally high or ultrahigh molecular weight), ethylene-tetrafluoroethylene copolymer (e.g., Tefzel™ (DuPont) and Halon™ ET (Ausimont, USA)), fluorinated ethylene propylene copolymer (e.g, as sold by DuPont), ethylene-chlorotrifluoro ethylene copolymer (e.g., Halar™ (Ausimont USA)), perfluoroalkoxy (e.g., as sold by DuPont), and blends or combinations thereof. In some embodiments of interest, fibrillatable polymers are supplied for forming the electrode composition with average particle sizes in the range(s) from about 0.1 microns to about 500 microns. A person of ordinary skill in the art will recognize that additional ranges within this explicit range of particle sizes are contemplated and are within the present disclosure. For compression molding processing of the electrode composition, fibrillatable polymers may or may not be used. Suitable polymers for compression molding include, for example, epoxies, styrene-poly(ethylene-butylene)-styrene triblock copolymer (e.g., Kraton®G (Shell)), styrene-butadiene-styrene triblock copolymer (e.g., Kraton®D (Shell)), phenolics (supplied by Capital Resins Corp.), modified polyphenylene oxide—styrene Noryl® supplied by General Electric), polytetrafluoroethylene (e.g., Teflon®9B, 602A, 610A, 612A, 640, K-10, CFP6000, 60, 67, and NXT (DuPont), Halon™ and Algoflon™ (Ausimont USA), Fluon™ (ICI America Inc.), Hostaflon™ (Hoechst Celanese) and Polyflon™ (Daikan)), modified ethylene chlorotrifluoroethylene (Vatar®, Ausimont USA), polyfurans (QO Chemicals), melamine (Oxidental Chemical), perfluoromethylvinylether (Hyflon®, Ausimont USA) and perfluoroalkoxy (Hyflon®, Ausimont USA). For metal-air cell applications, the polymers generally are selected to be relatively chemically inert after long exposure to high concentrations of OH⁻ at elevated temperatures and in the presence of electric fields.

For active electrode compositions, the solid phase of the electrode composition generally can comprise no more than about 80 weight percent electrically conductive particles and in further embodiments from about 20 weight percent to about 70 weight percent electrically conductive particles. For electrode backing layers, the solid phase of the electrode composition generally can comprise in the ranges from about 0 weight percent to about 50 weight percent electrically conductive particles and in further embodiments from about 5 weight percent to about 40 weight percent electrically conductive particles. A person of ordinary skill in the art will recognize that other ranges of amounts of electrically conductive particles are contemplated and are within the present disclosure.

The electrically conductive particles can comprise carbon conductors, such as carbon black, other carbon particles, metal particles, conductive metal compounds, or combinations thereof. Electrically conductive particles of particular interest comprise carbon black with a BET (Brunauer-Emmett-Teller) surface area in the ranges of at least about 200 m²/g, and in other embodiments from about 300 m²/g to about 1500 m²/g. A person of ordinary skill in the art will recognize that additional ranges of surface areas within the explicit ranges are contemplated and are within the present disclosure. Suitable carbon blacks generally include, for example, acetylene blacks, furnace blacks, thermal blacks and modified carbon blacks. Commercial carbon blacks generally are sold with specified BET surface areas, as measured by accepted ASTM test procedures. In addition, the carbon blacks can have an electrical resistivity as measured by accepted techniques by carbon black vendors of no more than about 0.01 ohm-cm. Furthermore, the carbon black may have an internal volume as determined by a DBP (dibutyl phthalate) absorption test of at least about 150 cm³/100 gm, and in other embodiments at least about 300 cm³/100 gm, wherein the internal volume is determined as set forth in standard test procedure ASTM D-2414-79. Specific suitable carbon blacks include, for example, ABC-55 22913 (Chevron Phillips, Houston, Tex.), Black Pearls (Cabot, Billerica, Mass.), Ketjen Black (Akzo Nobel Chemicals Inc., Chicago, Ill.), Super-P (MMM Carbon Division, Brussels, Belgium), Condutex 975® (Columbia Chemical Colo., Atlanta, Ga.), Printex XE (Degussa Corp., Ridgefield Park, N.J.) and mixtures thereof. In general, the electrically conductive particles, for example, carbon black, can be spherical, rod-shaped or any other suitable shape or combinations of shapes yielding an appropriate surface area and conductivity. For electrode applications, carbon black properties of particular interest include, for example, electrical conductivity, porosity and hydrophobicity. The characteristics and concentration of electrically conductive particles are generally selected to provide low electrical resistance, which is generally thought to result from obtaining conditions exceeding a percolation threshold, although not wanting to be limited by theory. Factors that influence electrical conductivity of electrical particles in a matrix include, for example, geometry of the matrix, crystallinity of the matrix, interactions between the electrical particles and the matrix, size and shape of the particles, surface area, degree of dispersion and concentration.

In general, the particulate components need not be homogenous materials, and may be blends of materials, such as blends varying in particle size, shape and/or surface area, which can be used to impart desired electrical, physical and processing properties.

While the electrically conductive particles may also function as catalysts for the reduction of molecular oxygen, generally a specific catalyst material is added to an active electrode layer. Catalysts, as described herein, broadly cover any material(s) that can catalyze a reduction-oxidation reaction. If two materials each provide electrical conductivity and catalytic activity, it may be arbitrary, which is called electrically conductive particles and which is called a catalyst. However, it may be desirable to add one material primarily as a catalyst and a second material primarily as an electrically conductive material. In some embodiments, the solid phase of the electrode composition comprises in the range(s) less than about 50 weight percent, in other embodiments in the range(s) from about 45 weight percent to about 5 weight percent and in further embodiments in the range(s) from about 10 weight percent to about 40 weight percent. A person of ordinary skill in the art will recognize that additional ranges within these explicit ranges are contemplated and are within the present disclosure. Generally, fluid, such as liquid, comprises the remaining weight of the electrode besides the solid phase of the composition. Suitable catalysts include, for example, elemental metal particles, metal compositions and combinations thereof. Suitable metals broadly cover all recognized metal elements of the periodic table and alloys thereof. Exemplary metals include without limitation, Fe, Co, Ag, Ru, Mn, Zn, Mo, Cr, Cu, V, Ni, Rh, and Pt. Suitable metal compositions include, for example, permanganates (e.g., AgMnO₄ and KMnO₄), metal oxides (e.g., MnO₂ and Mn₂O₃), decomposition products of metal heterocycles (e.g., iron tetraphenylporphyrin, cobalt tetramethoxyphenylporphyrin, cobalt complexes (e.g., tetramethoxyphenyl porphyrin (CoTMPP)), perovskites, cobalt pthalocynanine and iron pthalocynanine) and napthenates (e.g., cobalt napthenates and manganese napthenate) and combinations thereof. Elemental metals are un-oxidized metals in their zero oxidation state, i.e., M⁰. Suitable elemental metal particles include, for example, Ag, Pt, Pd, Ru, alloys thereof and combinations thereof. In general, the catalyst particles can be spherical, rod-shaped or any other suitable shape or combinations of shapes yielding an appropriate surface area.

Some metals for use as catalysts have a high cost. Therefore, cost savings can result from coating the elemental metal onto a less expensive particulate. For example, metals can be coated onto carbon black. In some embodiments, the catalysts comprise in the range(s) of at least about 80 weight percent carbon black and no more than about 20.0 weight percent metal, and in other embodiments from about 94.95 weight percent to about 99.9 weight percent carbon black, in the range(s) from about 0.1 weight percent to about 5.0 weight percent metal and in the range(s) from about 0.05 to about 5 weight percent nitrogen. To form the catalyst, carbon black is contacted with vapors of metal precursors and nitrogen precursors in a reducing environment. The metal may or may not be in elemental form and the carbon black may or may not be chemically bonded to metal and/or the nitrogen. The carbon black materials described above are also suitable for forming these catalyst materials. The carbon black-metal-nitrogen containing catalysts are further described in copending and commonly assigned U.S. Patent application Ser. No. 09/973,490 to Lefebvre, entitled “Methods of Producing Oxygen Reduction Catalyst,” incorporated herein by reference.

The fluid phase of the electrode composition generally comprises a liquid although supercritical fluids, dense gases and mixtures thereof can also be used. The fluid phase generally comprises in the range(s) of at least about 65 weight percent fluid and in further embodiments in the range(s) from about 90 weight percent to about 99 weight percent fluid, with the remainder of the fluid phase comprising dissolved compounds. Suitable fluids include, for example, water, alcohols (e.g., isopropanol and butanol), hydrocarbon solvents, aromatic solvents (e.g., toluene and xylene), ethers, esters, amides, amines, aldehydes, ketones, pthalates and combinations thereof. In some embodiments of particular interest, the fluid is an aqueous fluid, such as water.

In some embodiments, the fluid phase of the electrode composition optionally comprises one or more surfactants, i.e., surface active agents. The fluid phase of the electrode composition, if a surfactant is present, generally comprises in the range(s) from about 0.1 weight percent to about 10 weight percent surfactant(s), and in other embodiments in the range(s) from about 0.5 weight percent to about 5 weight percent surfactant(s). A person of ordinary skill in the art will recognize that additional ranges within these explicit ranges are contemplated and are within the present disclosure. The surfactant(s) can be non-ionic surfactants, cationic surfactants and anionic surfactants. In some embodiments, the fluid phase comprises nonionic surfactants, for example, surfactants in the class of polyoxyethyleneated alkyl phenols, such as compounds with a formula CₙHₙ₊₁C₆H₄O(C₂H₄O)ₓH (with n=4-18 and x=5-21), polyoxyethylene alcohols, such as compounds with a formula CₙHₙ₊₁(OC₂H₄)ₓOH (with n and x in the range(s) of n=4-18 and x=3-21) and mixtures thereof. Suitable specific surfactants include, for example, octoxynol-9 (9-10 ethylene oxide), e.g., sold as Triton®X-100 (Union Carbide), isolaureth-10 , e.g., sold as Tergitol® TMN-10 (Union Carbide), nonoxynol-8 (8.5 ethylene oxide), e.g., sold as Teric N8™ (ICI, Australia), nonoxynol-9 (9 ethylene oxide), e.g., sold as Teric N9™ (ICI, Australia), nonoxynol-10 (10 ethylene oxide), e.g., sold as Teric N10™ (ICI, Australia), and mixtures thereof. In some embodiments, the surfactant has a surface tension in the range(s) of from about 10 dynes/cm to about 35 dynes/cm at 23±2° C. A person of ordinary skill in the art will recognize that other range within this range are contemplated and are within the present disclosure.

The surfactant is generally removed during the electrode processing such that the surfactant is not present in the final electrode composition. The surfactant can be selected to evaporate and/or decompose into volatile compositions upon removal of the solvent, generally through evaporation. Residual surfactant may reduce the hydrophobicity of the backing layer, which could lead to, among other things, a loss of electrolyte through leakage. Residual surfactant may leach out into the electrolyte and decompose causing deterioration of the electrolyte and the anode. Residual surfactant or decomposed surfactant can also clog the electrode pores.

In some embodiments, the electrode composition optionally comprises one or more friction reducing agents or anti-wear agents. Some friction reducing agents are insoluble in the fluid while other friction reducing agents are soluble in the fluid, and a mixture of soluble and insoluble friction reducing agents can be used, if desired. For insoluble friction reducing agents, the solid phase of the electrode composition, in embodiments in which a friction reducing agent is present, comprises in the range(s) from about 0.1 weight percent to about 20 weight percent friction reducing agents, and in other embodiments in the range(s) from about 0.5 weight percent friction reducing agent to about 10 weight percent friction reducing agent. For soluble friction reducing agents, the fluid phase of the electrode composition, in embodiments in which a friction reducing agent is present, comprises in the range(s) from about 0.1 weight percent to about 10 weight percent friction reducing agents, and in other embodiments in the range(s) from about 0.5 weight percent friction reducing agent to about 5 weight percent friction reducing agent. A person of ordinary skill in the art will recognize that additional ranges within these explicit ranges are contemplated and are within the present disclosure. Suitable friction reducing agents include, for example, graphite, molybdenum disulphide, boron nitride, cadmium iodide, antimony thioantimate (Sb(SbS₄)), Sb₂O₃, amine phosphates, such as Vanlube® 672 (R.T. Vanderbuilt Company, Inc.), and mixtures thereof

The electrode composition can optionally comprise additional soluble or insoluble material, generally each at a concentration of no more than about 5 weight percent in either the fluid phase or the solid phase. Potential additional materials include, for example, fillers, viscosity modifiers, processing aids, stabilizers and the like and combinations thereof.

In general, active layers a more hydrophilic than the backing layers. For example, the backing layers can be essentially pure polymers that are hydrophobic, such as polytetrafluoroethylene, polyethylene, polypropylene or mixtures thereof. Generally, the active layer is sufficiently hydrophilic to provide for movement through the layer of electrolyte and ionic species.

For formation of an electrode, the electrode composition generally is formed into a sheet shape with a thickness much less than the linear dimensions defining the extent of the planar surfaces of the electrode. In some embodiments, the electrode has an average thickness in the range(s) of no more than about 5 millimeters (mm), in additional embodiments in the range(s) of no more than about 3 mm, in other embodiments in the range(s) of no more than about 2 mm, in further embodiments in the range(s) from about 1.5 mm to about 0.05 mm and in additional embodiments in the range(s) from about 1 mm to about 0.15 mm. In some embodiments, due to the improved processing approaches described herein, the thickness electrodes can be formed with a high degree of thickness uniformity across an electrode. In particular, in some embodiments, thickness of an electrode can vary by no more than about 0.1 mm from the average thickness. In addition, for a particular average thickness, the thickness across the electrode can vary in the range(s) of no more than about 30% from the average thickness and in further embodiments no more than about 20% from the average thickness. A person of ordinary skill in the art will recognize that additional ranges of electrode thickness and uniformity within these explicit ranges are contemplated and are within the present disclosure.

The thickness may or may not be approximately constant across the face of the electrode. In some embodiments of interest, the smallest edge-to-edge distance across the face of an electrode through the center of the electrode face is at least about 1 centimeter (cm). The shape of the face of the electrode can have any convenient shape, such as circular, oval or rectangular, for assembly into a galvanic cell or other device. In some embodiments, the electrode is roughly rectangular, although one or more of the edges may not be straight and one or more of the comers may or may not be square. For assembly into some embodiments of commercial fuel cells, it is desirable to have the smallest edge-to-edge distance across the face of the electrode though the center of the electrode to be in the range(s) of at least about 8 cm, in other embodiments in the range(s) of at least about 10 cm and in further embodiments in the range(s) from about 14 cm to about 200 cm. A person of ordinary skill in the art will recognize that additional ranges of electrode dimensions within the explicit ranges are contemplated and are within the present disclosure. Using the processing approaches described herein, low values of Gurley numbers are obtainable. Lower values of Gurley numbers reflect a greater porosity, as described further below. Gurley numbers at least as low as 124±15 have been obtained. Gurley number can be evaluated, for example, with an instrument from Gurley Precision Instruments, Troy, N.Y.

For the formation of an electrode assembly, the electrode composition can be combined with one or more current collectors, a backing layer and/or a separator, which separates the cathode from the anode. Backing layers and separators are described above. A current collector is a highly electrically conductive structure that is combined with the electrode composition to reduce the overall electrical resistance of the electrode assembly. Suitable current collectors can be formed from elemental metal or alloys thereof, although they can, in principle be formed from other materials. While in some embodiments a metal foil or the like can be used as a current collector, for gas diffusion electrodes, it is generally desirable to have a current collector that is permeable to the gaseous reactants such that the gas can flow through the cell. Thus, in some embodiments, the current collector comprises a metal mesh, screen, wool or the like. Suitable metals for forming current collectors that balance cost and convenience include, for example, nickel, aluminum and copper, although many other materials, metals and alloys can be used, as noted above. The current collector generally extends over a majority of the face of the electrode composition and may comprise a portion that extends beyond the electrode composition, for example, a tab that can be used to make an electrical connection to the current collector.

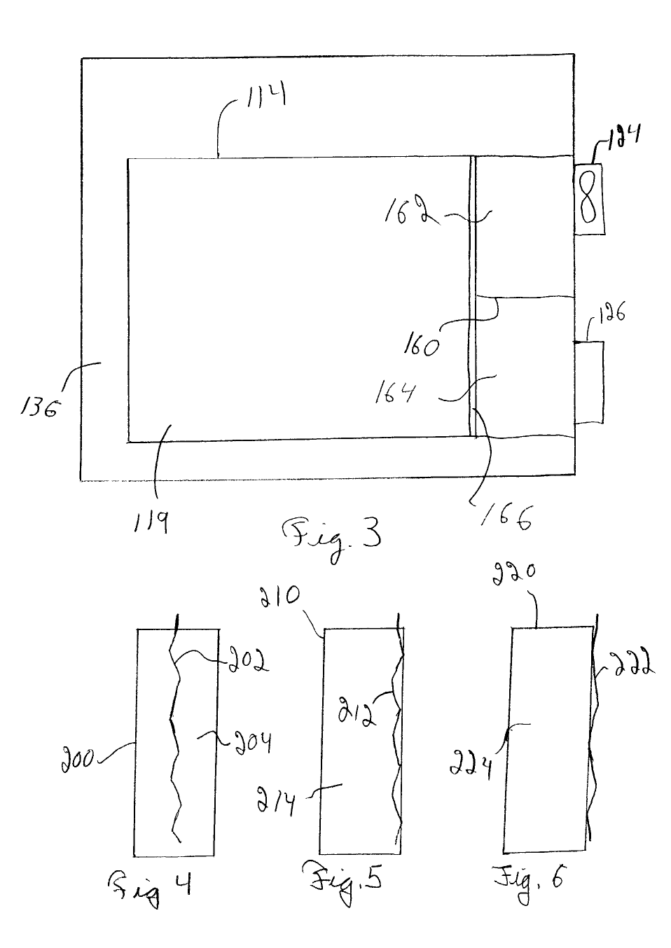

The electrode assembly may comprise an active electrode layer and/or an electrode backing layer and separator along with the current collector. If the electrode assembly comprises only a single electrode composition, the current collector can be embedded within the material, embedded below the surface and/or adhered to the surface. Representative structures of electrode assemblies are shown in FIGS. 4-6. Referring to FIG. 4, electrode assembly 200 comprises a current collector 202 embedded within electrode composition 204. Referring to FIG. 5, electrode assembly 210 comprises a current collector 212 embedded at the surface of electrode composition 214. Referring to FIG. 6, electrode assembly 220 comprises a current collector 222 attached at the surface of electrode composition 224.

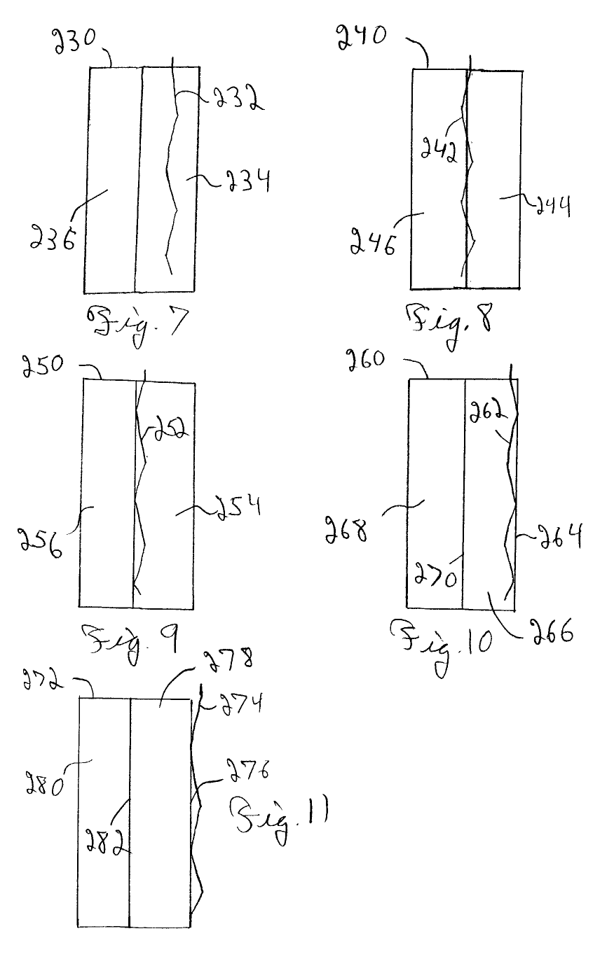

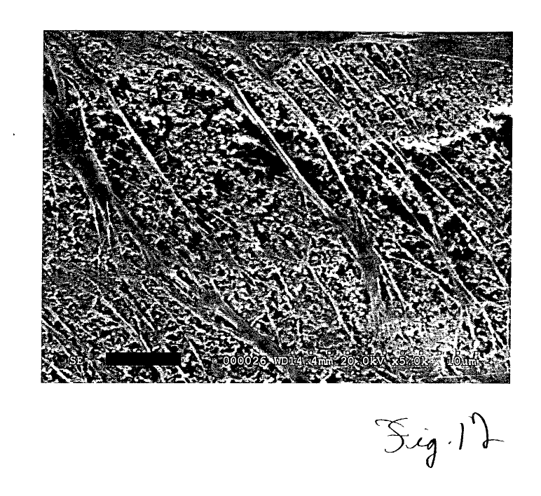

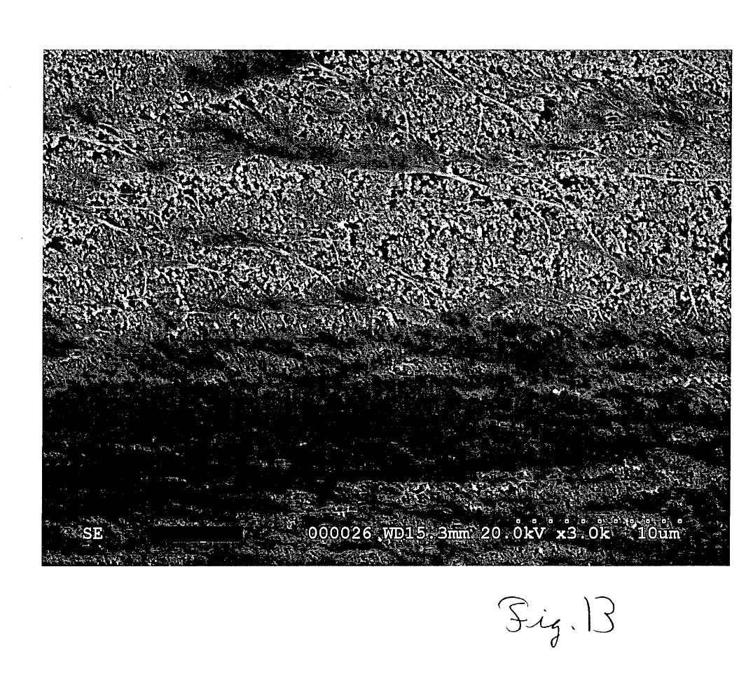

In alternative or additional embodiments, the electrode assembly comprises a plurality of layers with different electrode compositions, such as an active electrode layer and/or an electrode backing layer, a plurality of active electrode layers and/or a plurality of electrode backing layers. The current collector can be placed in several positions within the electrode assembly. Some representative structures are shown in FIGS. 7-11. Referring to FIG. 7, electrode assembly 230 comprises a current collector 232 embedded within a first electrode composition 234 and a second electrode composition 236 adjacent first electrode composition 234. Referring to FIG. 8, electrode assembly 240 comprises a current collector 242 embedded approximately within first electrode composition 244 and second electrode composition 246 at the interface between electrode compositions 244, 246. Referring to FIG. 9, electrode assembly 250 comprises a current collector 252 embedded below a face of first electrode composition 254 and a second electrode composition 256 adjacent the same face of the first electrode composition 254. Referring to FIG. 10, electrode assembly 260 comprises a current collector 262 embedded below a first face 264 of first electrode composition 266 and a second electrode composition 268 adjacent second face 270 of first electrode composition 266. Referring to FIG. 11, electrode assembly 272 comprises a current collector 274 attached to a first face 276 of first electrode composition 278 and a second electrode composition 280 adjacent a second face 282 of first electrode composition 278. Additional or alternative embodiments comprising a plurality of active electrode layers, a plurality of electrode backing layers and/or a plurality of current collectors can be formed by straightforwardly generalizing the basic structures shown in FIGS. 4-11.

Electrode and Electrode Assembly Processing

The processing of the electrode composition and/or the electrode assembly comprises combining the components of the electrode composition, forming the desired electrode structure(s) and optionally combining components to form an electrode assembly. The formation of a fibrillated structure using a fibrillatable polymer generally comprises the application of sufficient shear to result in the desired fibrillation. The fibrillation can result in desired porosity while obtaining desired mechanical properties of the electrode composition and good binding of particulates. The desired shear can be applied in one or more steps that can comprise, for example, high shear mixing, extruding and/or calendering. At least some of the shaping of the electrode composition can be performed simultaneously with the application of the shear. Additionally or alternatively, the electrode composition can be shaped using molding, such as compression molding.

Generally, the components of the cathode compositions are combined and mixed, although not all components need to be combined simultaneously. Before mixing, the powders can be pulverized, for example, using an air impact pulverizer. Suitable air impact pulverizers include, for example, Tost Model T-15 manufactured by Plastomer Technologies (Newton, Pa.) or a Rotomill model 1000 or model 1300 manufactured by International Process Equipment Co. (Pennsauken, N.J.).

In many embodiments, the polymers impose a high viscosity to the combined electrode composition such that the mixing requires considerable shear to combine the ingredients. The mixing can be preformed in corresponding mixing apparatuses that can impose the corresponding shear. For example, the mixing or a portion thereof can be performed in a blender or a mill or the like. Some specific mills and blenders are described in the examples below. Generally, the mixture is mixed for sufficient time to form an approximately homogenous paste. The specific amount of time can be selected based on the particular equipments and processing conditions. Liquid components can be added at one or more points in the processing and can be added to replace liquid lost during processing and/or to alter the processing properties.

Following the blending of the solid components, the electrode composition can be shaped. In some embodiments, the mixture is extruded through a die. Various extruders can be used, such as a twin screw extruder, a ram extruder and the like. Suitable ram extruders include, for example, ram extruders from, for example, Jennings Corporation (Norristown, Pa.) or from WK Worek U.S.A. Ramsey, N.J.). The extrusion generally is performed at pressures in the range(s) of no more than about 20,000 psi gauge (psig), in other embodiments in the range(s) of no more than about 10,000 psig and in further embodiments in the range(s) from about 1,500 psig to about 6,000 psig. For ram extrusion, the corresponding velocity of the ram in the extruder can be in the ranges of at least about 3 cm/sec and in further embodiments from about 5 cm/sec to about 100 cm/sec. A person of ordinary skill in the art will recognize that additional ranges of extrusion pressures and ram velocities within the explicit ranges are contemplated and are within the present disclosure. The extrusion is performed through a die opening.

The die opening of the extruder can have any reasonable shape, such as a slit, a circle, an oval or the like. The size and shape of the die opening determines the characteristics of the electrode composition for further processing. For forming large commercial scale electrodes for fuel cell applications, it may be desirable to have a relatively large die opening. In some embodiments, the die opening has a dimension in a range(s) of at least about 6 centimeters (cm), in further embodiments in the range(s) of at least about 8 cm, in additional embodiments in the range(s) from about 12 cm to about 500 cm, in which dimensions are measured through the center of the die. A person of ordinary skill in the art will recognize that additional ranges within these explicit ranges are contemplated and are within the present disclosure. While the die opening can have a variety of possible shapes, in some embodiments of interest, the die has a shape of a rectangular slit with a dimension corresponding to the thickness of the extrudate in the range(s) of no more than about 1 cm, in other embodiments in the ranges of no more than about 5 millimeters (mm), and in additional embodiments in the range(s) from about 2.5 mm to about 0.05 mm. A person of ordinary skill in the art will recognize that additional ranges within these explicit ranges are contemplated and are within the present disclosure.

The extrusion can be performed at any temperature in which the electrode composition has a sufficiently low viscosity that the composition can be extruded to allow fibrillation of the polymer system. In some embodiments, the extrusion is performed at room temperature or at an elevated temperature. In embodiment in which the extrusion is performed at an elevated temperature, the temperature can be in the range(s) from about 30° C. to about 80° C., and in further embodiments in the range(s) from about 40° C. to about 70° C. A person of ordinary skill in the art will recognize that additional ranges within these explicit ranges are contemplated and are within the present disclosure.

The mixing and optional extruding apply shear to the fibrillatable polymer that can induce fibrillation of the polymer. In addition, in the relevant embodiments, extrusion can shape the electrode composition to have a particular thickness and shape or geometry. However, even in embodiments in which the electrode composition is extruded, it may be desirable to calender the electrode composition. Calendering broadly includes passing the composition through a gap, generally formed by opposing pairs of moving members. Suitable moving members include, for example, rollers, belts and the like. Thus, in some embodiments, the calendering is performed by passing the electrode composition through a pair of rollers that are rotating to propel the electrode composition through the rollers. Similarly, calendering can be performed by passing the electrode composition through moving opposing pairs of moving belts, such as translating belts or rotating pairs of continuous belts. Multiple passes through a gap can be performed by using temporally sequential passes through a particular gap with the width of the gap adjusted appropriately and/or by sequentially positioned multiple sets of gaps, for example, multiple pairs of rollers placed sequentially in position.

Calendering applies shear forces when the gap is smaller than the initial thickness of the material. Thus, calendering generally also forms a thinner material than the initial material prior to calendering, although resiliency of the material may result in a final material that is not as thin as the calender gap. In some embodiments, a plurality of passes through a gap is performed, in which each subsequent gap may or may not have a smaller gap. For example, the electrode composition can be passed through at least two gaps, three gaps, etc. and generally less than about 50 gaps. While between any two passes through the calender, the gap may or may not be decreased, the gap generally is decreased over a plurality of passes to achieve the final desired electrode thickness. Also, the material may or may not be turned between passes through the gap. In some embodiments, calendering devices comprise either rollers or belts to establish the gap, corresponding to the distance between two opposing members forming the gap. Any suitable calendering apparatus can be used including, for example, conventional calendering devices. Examples of suitable calendering devices include, for example, a two-roll mill from Reliable Rubber and Plastic Machinery Co. (New Jersey), Faustel Inc. (Germantown, Wis.) or Fairview Machines (Chicopee, Mass.).

The calendering can be performed at any temperature at which the polymer is suitably processable. For example, in some embodiments, the calendering can be performed at room temperature or at higher temperatures. In general, the calendering is performed at temperatures in the range(s) from about 25° C. to about 85° C., in further embodiments in the range(s) from about 30° C. to about 80° C., and in other embodiments in the range(s) from about 45° C. to about 70° C. In general, the temperature of the calendering is established by heating the calender rollers or other corresponding moving elements forming the gap. A person of ordinary skill in the art will recognize that additional ranges within the explicit ranges of temperature are contemplated and are within the present disclosure.

The rotation speed of the calender rollers, belts or the like affect the properties of the calendered materials. For example, a faster calendering speed can lead to tearing of the material or to the formation of pin holes or cracks. In general, the roller speeds range from about 0.05 revolutions per minute (rpm) to about 50 rpm and in other embodiments from about 0.1 rpm to about 10. The roller/belt speeds of the opposing members of the gap can be set to be the same or different. Having different speed of opposing members of the gap applies shear to the structure during calendering, which results in a calendered structure having a soft and a hard side. The hard side forms against the roll with the higher speed since this side has fibrillated more and hence is more porous. The hard side can be placed in front of the anode and electrolyte, for the active layer. A slow speed roll can also provide a different surface finish such as a rougher surface to improve the lamination of the two layers due to better mechanical interlocking. In general, the ratio of roller rates is in the range from at least about 0.1 to about 1. A person of ordinary skill in the art will recognize that additional ranges within the explicit ranges of roller speed and roller speed ratios are contemplated and are within the present disclosure. The surface finish of the rollers can also affect the surface properties of the resulting calendered film. For example, the rollers can have a chrome-plated surface with a mirror finish, such as with a #2 micro inch smoothness or a #20 micro inch smoothness.

The electrode shape and size are selected to be appropriate for the corresponding cell into which the electrode is placed. Appropriate shapes and sizes for electrodes are described above. The electrodes materials can be selected and processed to produce electrodes with approximately the desired shape and size. In alternative embodiments, the electrodes can be cut to the desired sizes using available cutting tools.

Additionally or alternatively, electrode structures can be formed by compression molding. To perform the compression molding, the electrode materials are generally formed into a paste as described above using a mixer. The paste is then transferred to the mold of a compression molding apparatus. Compression molding has been used for the formation of electrodes for batteries using PTFE binders. See, for example, U.S. Pat. No. 6,413,678 to Hamamoto, et al., entitled “Non-Aqueous Electrolyte And Lithium Secondary Battery Using The Same,” U.S. Pat. No. 6,001,139 to Asanuma, et al., entitled “Nonaqueous Secondary Battery Having Multiple-Layered Negative Electrode, and U.S. Pat. No. 5,705,296 to Kamauchi, et al., entitled “Lithium Secondary Battery,” all three of which are incorporated herein by reference. These methods can be generalized for the formation of commercial scale fuel cell electrodes as described herein. In general, a pressure on the order of 100 pounds per square inch gauge (psig) to about 15,000 psig are used in the compression mold. Temperature generally is in the ranges from about 50° C. to about 350° C. The temperature can be used to control the melt viscosity to get a good distribution of resin throughout the mold. A vacuum, for example, in the ranges from about 5 inches of mercury to about 30 inches of mercury, can be pulled before heating to remove air between the particles and a liquid pore former. Similarly, polymer particle sizes from about 3 microns average diameter to about 50 microns average diameter can help to get a good distribution of the powders throughout the mold. A person of ordinary skill in the art will recognize that additional ranges of compression molding parameters in addition to the specific ranges above are contemplated and are within the present disclosure.

The electrodes can be dried before or after completing the calendering and/or compression molding. In addition, at least some drying can take place during some of the other processing steps. For example, liquid can be removed due to mechanical forces and/or evaporation during extrusion, calendering and/or compression molding. If liquid is removed as a byproduct of the processing, additional liquid can be added to prevent drying prior to desired drying times and to provide desired processing characteristics of the electrode composition. Furthermore, the electrode structure can be further dried to remove desired amounts of liquid after completion of forming the desired electrode thickness or before achieving a desired electrode thickness. The drying can be performed at room temperature or under heating. In addition, the electrode composition can be dried, for example, at atmospheric pressure or under reduced pressure. The electrode composition can be dried to remove substantially all of the liquid or some portion thereof to yield a desired porosity and mechanical properties. Drying can be facilitated with microwaves, infrared heating and or hot air. In some embodiments, the drying is performed with heating and cooling rates of no more than about 7 degrees per second. In further embodiments, the drying is performed at a fixed temperature by placing the electrode composition in a hot oven or the like such that there is no heating rate. The cooling can be performed, for example, at a rate from about 2 degrees per minute to about 5 degrees per minute.

The electrode composition can be associated with a current collector to form an electrode assembly. The electrode assembly can comprise various structures as described above. The association can be performed with an electrically conductive adhesive, such as a carbon particle-containing adhesive/polymer. Alternatively or additionally, the current collector can be associated with one or more electrode compositions by laminating the current collector to the electrode composition(s) for example in a press, with a calender apparatus or the like. Laminating the current collector with one or more electrode compositions may or may not result in a reduction of the thickness of the electrode composition. The lamination can be repeated, if necessary, to achieve a desired level of adhering of the current collector. Similarly, the pressure in a press and the gap dimensions of a calender can be selected to yield a desired level of adhering.

Furthermore, the electrode, with or without the current collector, can be associated with backing layer and/or a separator. In particular, the electrode can be combined with one or more of these other elements of an electrode assembly through lamination, for example, through a calender. Suitable roller speeds for this lamination are, for example, 0.3 rpm to 5 rpm, and suitable temperatures are in the range(s) from about 50° C. to about 330° C. A person of ordinary skill in the art will recognize that additional ranges within these particular ranges are contemplated and are within the present disclosure.

Stacks and Fuel Cell Assembly/Use

Electrodes and/or electrode assemblies can be assembled into stacks for use as a fuel cell assembly. The specific numbers and/or types of electrodes can be selected depending on the intended use of the fuel cell. A stack of electrodes and/or separators are generally mounted into a housing. The housing provides the desired degree of contact between adjacent elements such that resistance with respect to ionic flow, gas flow and/or electrical flow are within desired ranges. Representative structures are described in more detail above.

The fuel cell can be assembled without fuel, electrolyte and/or oxidizer present. Fuel cell can then be stored for later use. When ready for use, the fuel cell can be supplied with fuel, oxidizer and/or electrolyte to complete the fuel cell. The oxidizing agent, fuel and/or electrolyte each can be supplied in batch form or continuously.

The fuel cell may be used to power a load which, as used herein, includes, for example and without limitation, telecommunications equipment, Internet servers, corporate mail servers, routers, power supplies, computers, test and industrial process control equipment, alarm and security equipment, many other types of electrical devices, equipment for which a power source is necessary or desirable to enable the equipment to function for its intended purpose, and the like, and suitable combinations of any two or more thereof. Additional examples of loads include lawn & garden equipment; radios; telephone; targeting equipment; battery rechargers; laptops; communications devices; sensors; night vision equipment; camping equipment (stoves, lanterns, lights); lights; vehicles (both primary and auxiliary power units, with or without regeneration unit on board, and with or without capability of refueling from a refueling station, including without limitation, cars, recreational vehicles, trucks, boats, motorcycles, motorized scooters, forklifts, golf carts, lawnmowers, industrial carts, passenger carts (airport), luggage handling equipment (airports), airplanes, lighter than air crafts (e.g., blimps, dirigibles, etc.,), hovercrafts, trains (locomotives), and submarines (manned and unmanned); torpedoes; and military-usable variants of above.

As employed herein, the term “in the range(s)” or “between” comprises the range defined by the values listed after the term “in the range(s)” or “between”, as well as any and all subranges contained within such range, where each such subrange is defined as having as a first endpoint any value in such range, and as a second endpoint any value in such range that is greater than the first endpoint and that is in such range.

### EXAMPLES

### Example 1

Electrodes Formed by Calendering PTFE with Water

Zinc-air fuel cells with good performance characteristics were produced with electrodes prepared using calendering of polytetrafluoroethylene (PTFE) with an aqueous liquid. The process involved preparing an active layer and a backing layer from their respective raw materials. Once the active layer and the backing layer were prepared, the layers were co-laminated together along with a current collector to complete an electrode assembly.

Eight electrodes were produced. To prepare each active layer, 23.3 g of PTFE-T60 (Dupont), 46.7 g of ABC-55 carbon black (Chevron Chemical Company) and 30 g of Pt-10 on Vulcan XC-72 catalyst (Johnson Matthey) were mixed in a beaker at 25±2° C. The resulting powder was then blended at low speed for 15 seconds, medium speed for 15 seconds and high speed for 90 seconds in a 4 liter industrial blender. A Triton X-100 (non-ionic surfactant) solution was prepared by diluting 1.35 g of Triton X-100 with distilled water in a 100 mL volumetric flask. A 15 g amount of the blended powder was combined with 35 g of an aqueous solution of 1.35 weight percent Triton X-100 (Union Carbide) in a beaker. The mix was then stirred until the powder began to coagulate. The coagulated dough was then removed and hand worked into a dough ball. A standard Ziploc® bag was used for storing the dough balls.

For roll mixing, a two-roll junior mill from Reliable Rubber and Plastic Machinery Co. was used. The roll mill rollers were preheated to 90° C., the nip was set to 135, and the roller speed was set to 2.5 rpm. The dough balls were then each subjected to a total of 4 mixing passes. The 4 mixing passes comprised first passing the dough ball through the mill 1 time, then rolling by hand the resulting sheet into a cigar shape and passing the cigar shaped material in the rolling direction (i.e. the 0° direction) two times, followed by 1 inverted cigar pass (i.e. the film was rotated 90° on the last pass).

Keeping the roll mill speed at 2.5 rpm and the temperature of the rollers at 90° C., the active layers were then calendered using the two-roll junior mill. As set forth in Table 1 below, calendering consisted of 8 passes at 6 different nip/gap settings. The first 2 passes were roll mixes and the last six passes were cross roll mixes. For the second passes at nip/gap settings of 78 and 64 the film was turned over.

TABLE 1
Nip/gap settings for calendering.

| | Gap | Speed |
|---|---|---|
| Nip | (mm) | (rpm) |
| 114 | 2.82 | 2.5 |
| 98 | 2.38 | 2.5 |
| 78 | 1.89 | 2.5 |
| 78 | 1.89 | 2.5 |
| 64 | 1.55 | 2.5 |
| 64 | 1.55 | 2.5 |
| 36 | 0.83 | 2.5 |
| 17 | 0.35 | 2.5 |

After the last pass, the calendered sheet was placed in a vacuum oven at 30 inch Hg and dried for 2 hours at 170° C. The sheet was then cooled in the oven while bleeding with nitrogen gas. Finally, the active layer sheet was trimmed to form a 7 cm×4.6 cm rectangle for use in the electrode assembly. Each backing layer was prepared by mixing 50 g of PTFE-T60 (Dupont) and 50 g of ABC-55 carbon black (Chevron Chemical Company) in a beaker at 25±2° C. The resulting powder was then blended at low speed for 15 seconds, medium speed for 15 seconds and high speed for 90 seconds in a 4 liter industrial blender. A 15 g portion of the blended powder was combined with 21.5 g of 1.35 weight percent Triton X-100 aqueous solution in a beaker. The mix was then stirred until the powder began to coagulate. The coagulated dough was then removed and hand worked into a dough ball. A standard Ziploc® bag was used for storing the dough balls. Each backing layer dough ball was then roll mixed and calendered in the same manner as the active layer dough ball, as described above.

To assemble an electrode assembly of this example, a backing layer was first co-calendered to a current collector. Prior to co-calendering, a sandwich structure was created consisting, from bottom to top, of an 0.11 mm thick piece of wax paper, an 0.08 mm thick piece of aluminum foil, the backing layer, and a piece of Ni-metal mesh. The sandwich was passed through the roll mill (calender parameters: roller temperature of 100° C., 0.45 mm gap, and roll speed of 0.75 rpm). After passing the structure through the roller, the aluminum foil and wax paper were removed. If the current collector was not adhered to the backing layer at this point, the co-calendering process was simply repeated.

A laminating procedure was used to complete the cathode assembly. The active layer sheet and backing layer sheet (with the current collector adhered) were cleaned using compressed air. Graphite release agent was sprayed on 1 side of 2 sheets of thick aluminum foil. The backing layer was placed on the aluminum foil, with the current collector resting against the aluminum foil. The active layer was placed on the backing layer, and the second aluminum foil sheet was placed on top of the active layer with the graphite-covered side facing out. This sandwich was placed on a Carver press, which had been preheated to 330° C., and pressed at 80 psi for 10 minutes. Before removing the aluminum foil, the cathode assembly was cooled.

The properties of the electrodes prepared according to the forgoing method are listed in Table 2. In particular, Table 2 shows the thickness and corresponding Gurley number of various cathodes prepared using this method. The Gurley number reflects the porosity of the particular cathode. Specifically, the Gurley number is a measurement of the time for a 10 cubic centimeter volume of air to pass through a one square inch area of film at a standard pressure. The Gurley number was evaluated with a Model 4240 instrument from Gurley Precision Instruments, Troy, N.Y.

Additionally, FIG. 12 shows the scanning electron micrograph of a cathode prepared by this method. The figure illustrates the fibrillation of the PTFE and the porosity of the cathode. In the above example, thermogravimetric analysis was also performed on the active layer, backing layer and cathode to confirm that no surfactant remained. Specifically, thermogravimetric analysis (TGA) was used to measure the change of mass of a sample as a function of temperature. In this case percent weight loss of a known sample weight was measured under nitrogen from 30 to 600° C. at 10° C/minute. The TGA instrument (TA Instruments, New Castle, Del.) was equipped with a microbalance to weight the sample as a function of temperature.

The electrodes were tested as a cathode within a zinc-air fuel cell essentially as described above. Each cathode was tested for a set number of hours using a 35% KOH electrolyte. Table 2 also shows the performance of the electrodes prepared by this method when incorporated into a zinc-air fuel cell. Shown in Table 2 are the corresponding voltages at 200 mA/cm² for each cathode.

TABLE 2
Properties of cathodes and performance of fuel
cells from Example 1.

| | | Thickness | | Hours on | Voltage at |
|---|---|---|---|---|---|
| Cathodes | GN | (mm) | Electrolyte | test | 200 mA/cm² |
| 31C-A | 196 | 0.97 | 35% KOH | 432 | 0.98 |
| 31C-B | 204 | 0.96 | 35% KOH | 456 | 1.02 |
| 31C-C | 236 | 0.95 | 35% KOH | 288 | 0.93 |
| 31C-D | 162 | 0.96 | 35% KOH | 288 | 0.95 |
| 31C-E | 158 | 0.95 | 35% KOH | 312 | 0.99 |
| 108E-1 | 289 | 0.93 | 35% KOH | 624 | 1.06 |
| 108E-2 | 299 | 0.86 | 35% KOH | 624 | 1.04 |
| 108E-9 | 279 | 0.89 | 35% KOH | 624 | 1.09 |

### Example 2

Fuel Cell Cathodes Using Tergitol® Surfactant

Zinc-air fuel cells were prepared with electrodes made by calendering PTFE and an aqueous solution with Tergitol® non-ionic surfactant.

With the exception of several noted modifications, this example utilized the same procedure as describe above in Example 1. With respect to the surfactant, instead of a 1.35 weight percent Triton X-100 aqueous solution, this example utilized a 2.0 weight percent Tergitol® TMN-10 (isolaureth-10, Union Carbide Corp.) non-ionic surfactant aqueous solution. The Tergitol® solution was prepared by diluting 1.35 g of Tergitol® TMN-10 with deionized water in a 100 mL volumetric flask. Furthermore, for preparation of the active layer, 30 g of the surfactant solution was mixed with 15 g of the blended active layer powder mixture, and for the backing layer, 21.5 g of the surfactant solution was mixed with 15 g of the blended backing layer powder mixture.

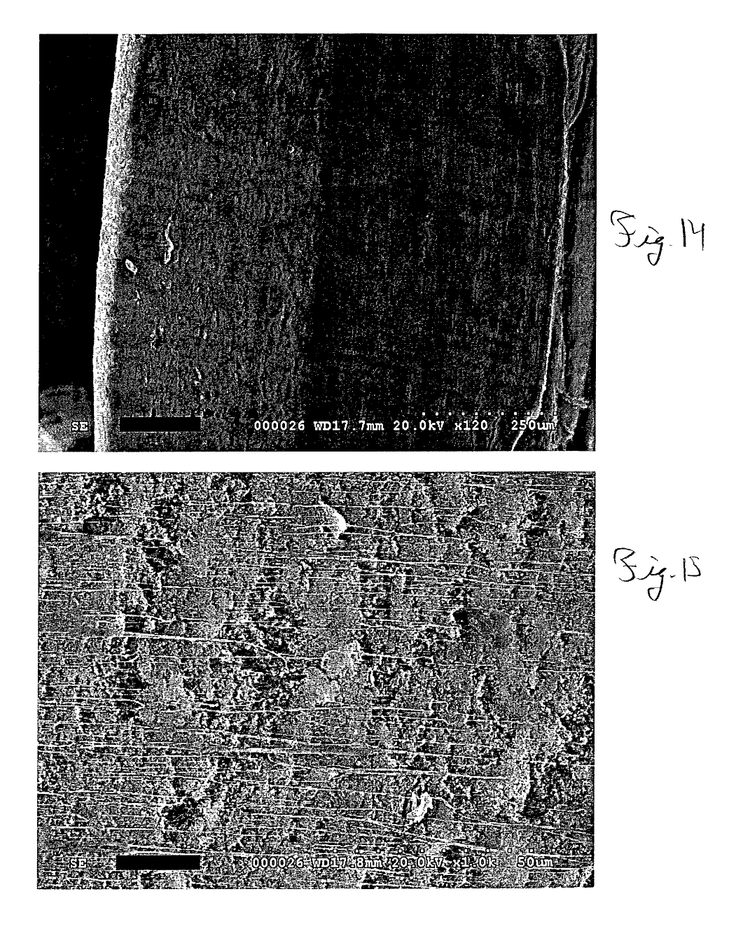

Table 3 lists some properties of the electrodes prepared according to the method of this example. In particular, Table 3 shows the thickness and corresponding Gurley number of various cathodes prepared using the method of this example. Additionally, FIG. 13 shows the scanning electron micrograph of a cathode prepared by this method, which further illustrates the fibrillation of the PTFE and the porosity of the cathode. The Gurley number was evaluated with a Model 4240 instrument from Gurley Precision Instruments, Troy, N.Y.

Table 3 also shows the performance of the electrodes prepared by this method when incorporated into a zinc-air fuel cell. In this particular example, the electrodes were tested as cathodes within a zinc-air fuel cell. Each cathode was tested for a set minimum number of hours using a 35% KOH electrolyte. Shown in Table 3 are the corresponding best and average voltages for each cathode.

TABLE 3
Properties of cathodes and performance of corresponding fuel
cells from Example 2.

| | | | Thickness | | Test | Best V/ |
|---|---|---|---|---|---|---|
| Cathode | Comments | GN | (mm) | Electrolyte | hours | Ave. V |
| 58EA | 2% TMN-10 | 259 | 0.98 | 35% KOH | >504 | 1.06/0.8 |
| 58EB | 2% TMN-10 | 279 | 0.96 | 35% KOH | >504 | 1.07/0.9 |
| 58ED | 2% TMN-10 | 202 | 1.01 | 35% KOH | >504 | 1.05/0.88 |
| 70D | 2% TMN-10 | 396 | 0.94 | 35% KOH | >528 | 1.07/0.86 |
| 70E | 2% TMN-10 | 412 | 0.94 | 35% KOH | >528 | 1.07/0.9 |
| 70F | 2% TMN-10 | 412 | 0.96 | 35% KOH | >504 | 1.08/0.9 |

### Example 3

Fuel Cell Electrodes Extruded with an Aqueous Solution

Fuel cell cathodes were formed by extruding PTFE with an aqueous liquid and calendering the extrudate.

In the method of this example, the preparation of the active layer involved preparing a powder, pulverizing the powder, blending the powder with water, extruding the blend, and calendering the extrudate. The blending was done using a V-blender. Pulverization was carried out using a Trost T-15 Jet Mill (Goodrich Plastomer Products), which had the following components: Syntron FM TOC-¾ feeder; steel stand; stainless steel cyclone; 15 gallon fiber drum; air relief bag; and standard jets, gauges, and valves with connecting fittings for each jet line. The extruding was done with a custom made ram extruder (Phillips Scientific) containing a 3 inch inner diameter extruder barrel.

To prepare approximately 30 kg of the active layer powder, 23.3 g of Teflon T60 (Dupont), 10 g of Vulcan XC72 (Johnson Matthey), 53.7 g of ABC 55 (Chevron-Phillips), and 15 g of Thermopure 5535 (Superior Graphite) were mixed in a 500 ml plastic beaker. Eight of such beakers were added to the V-blender and blended for 5 minutes. The active layer powder was transferred to a plastic lined 55 gallon drum. Pulverization of the active layer powder was then carried out using a Trost T-15 Jet Mill, with a feed rate of 19.5 kg/hr and an inlet pressure 84,368 kg/m².

Subsequently, the pulverized powder was blended with a 2.7 weight percent Triton X-100 aqueous solution using the V-blender and a 5 gallon Speedy Sprayer, PT500 Paint Tank (Federal Equipment Co.). The 2.7 weight percent Triton X-100 aqueous solution was prepared by adding 270 g of Triton X-100 to 730 g of hot, distilled water, and then adding this solution to the 5 gallon Paint Tank, which contained 9 kg of distilled water. After stirring, the top of the Paint Tank was secured, and the air pressure was adjusted to 25 psi. An air hose was attached to the Paint Tank. A liquid feed hose was also attached from the Paint Tank to the V-blender. The filled Paint Tank was then placed on a 32 kg scale and tared. Next, 980 g of pulverized active layer was added to the V-blender, filter paper was placed between the cover and the V-blender, and the V-blender cover was secured.

The V-blender shell and high intensity bar motors were turned on, and the flow valve from the Paint Tank to the V-blender was opened (adjusting flow rate to 50 to 60 on gage). By monitoring the weight loss of the lubricant on the scale, 700 g of the 2.7% Triton X-100 was delivered from the Paint Tank to the V-blender. The V-blender shell and intensifier motors were turned off, and any additional lubricant added was recorded. The V-blender was opened and 350 g of pulverized active layer powder was added, and then the V-blender cover was again secured. The procedure outlined in this paragraph was then repeated two times for a total of three times.

The V-blender shell and intensifier motors were turned back on, and using the same weight loss measuring method, 700 g of the 2.7 weight percent Triton X-100 solution was added to the V-blender, again being careful to record the exact amount of lubricant actually delivered. After delivery of the Triton X-100 solution, the V-blender shell and intensifier motors were turned off.

The V-blender was then opened and 250 g of pulverized active layer powder was added. After securing the V-blender cover, the shell and intensifier motors were turned back on, the Paint Tank flow valve re-opened (adjusting flow rate to 50 to 60 on the gage), and 800 g of the Triton X-100 lubricant was added to the V-blender. The V-blender shell and intensifier motors were turned off. The steps outlined in this paragraph were then repeated two times for a total of three times.

The V-blender was opened, 220 g of the pulverized active layer powder was added, and the V-blender cover was secured. The V-blender shell and intensifier motors were turned on, the flow valve on the Paint Tank was opened (adjusted the flow rate to 50 to 60 on the gage), and 410 g of the lubricant was added. This time, after closing the flow valve the blender remained on for 5 minutes. The lubricant-wet active layer powder was transferred to a double plastic bag lined 5-gallon square plastic drum, the plastic liners were closed, and the plastic drum was closed and secured.

The Phillips Scientific extruder, with a 3-inch inner diameter barrel, was preheated to 37 to 41° C. Approximately 500 ml of water-wet cotton rags were inserted into the bottom of the extruder. The extruder was filled with approximately 4.5 kg of wet active layer powder. Approximately 500 ml of water-wet cotton rags were placed on top of the active layer powder. Then, a deadhead extruder cap was secured to the extruder barrel and the vacuum line was attached. The vacuum pump was engaged to apply 5 to 10 inches of water vacuum. After setting the hydraulic pressure limit to 750 psi, the hydraulic system pressure was allowed to slowly increase to 750 psi over the course of about 20 minutes. The preform was allowed to dwell at 750 psi for 20 minutes under vacuum. After 20 minutes, the vacuum and hydraulic pressure were released, and the deadhead extruder cap and the top layer of cotton rags were removed. The hydraulics was turned on to expose the first 3 inches of the preform, and the hard preform puck was removed. The underlying preform remained soft.

A 10-inch wide fan die with a 0.030 slit opening was attached to a master nozzle. The master nozzle and die were then preheated to between 37 and 45° C., and attached to the extruder barrel. Once engaged, the hydraulic system pressurized the RAM at a rate approximately equal to 6 gallons per minute, or until the pressure stalled at 5000 psi. After extrusion, the extruded film was collected and rolled onto a spool.

For calendering, the roller temperature was set to 60° C., the gap was adjusted to 0.35 mm, and the roll speed was set at 10 rpm. The extruded film was cut to form an 18 cm wide by 25 cm long (extrusion direction) film, and this cut film was then fed into the calender mill. After calendering, the calender films were dried in a vacuum oven at 150° C. at 30 inches of Hg for one hour.

The backing layer was prepared in a manner similar to the active layer. To prepare approximately 30 kg of the backing layer powder, 50 g of Teflon T60 and 50 g of ABC 55 were mixed in a 500 ml plastic beaker. Eight of such beakers were added to the V-blender and blended for 5 minutes. The backing layer powder was transferred to a plastic lined 55 gallon drum, and was then pulverized in the Trost T-15 using a feed rate of 31.8 kg/hr and an inlet pressure 84,368 kg/m².

Subsequently, the pulverized backing layer powder was blended with a 2.7 weight percent Triton X-100 aqueous solution using the V-blender and the Paint Tank. Note a 10 kg quantity of 2.7 weight percent aqueous solution of Triton X-100 was prepared as outlined above. The Triton X-100 solution was again pressurized to 25 psi in the Paint Tank, and a liquid feed hose was attached from the Paint Tank to the V-blender. The filled Paint Tank was placed on a 32 kg scale and tared. Next, 1800 g of pulverized backing layer was added to the V-blender, filter paper was placed between the cover and the V-blender, and the V-blender cover was secured.

The shell motor and high intensity bar motor of the V-blender were turned on, and the flow valve from the paint tank to the V-blender was opened (adjusting flow rate to 50 to 60 on gage). By monitoring the weight loss of the lubricant on the scale, 600 g of the 2.7% Triton X-100 was delivered from the Paint Tank to the V-blender. The V-blender shell and intensifier motors were turned off, and any excess lubricant added was recorded. The V-blender was opened, 480 g of pulverized backing layer powder was added, and the V-blender cover was again secured. The procedure outlined in this paragraph was then repeated three times.

The V-blender shell and intensifier motors were turned on, the flow valve on the Paint Tank was opened and adjusted to 50 to 60 on the gage, and 3,122 g of the Triton X-100 was added. After closing the flow valve, the blender remained on for 5 minutes. The total pulverized backing layer powder addition for the above procedure should be 3.24 kg, and total Triton X-100 lubricant solution added should equal 4.92 kg. The lubricant wet backing powder was transferred to a double plastic bag lined 5-gallon square plastic drum, the plastic liners were closed, and the plastic drum was closed and secured.

The lubricant-wet backing powder was then subjected to extrusion, calendering and drying. The parameters for these treatments were the same as for the lubricant-wet active powder, as described above, except that the calender roll speed was set at 5 rpm instead of 10 rpm. The backing layer was prepared by extrusion using the same conditions as those for the active layer.

After drying, both the active layer films and backing layer films were die cut using a 31.82 cm² die. Using aluminum foil and wax paper, a Ni mesh was then co-calendered to the backing layer as described in the previous examples (the calender rolls were heated to 100° C., the gap was 0.38 mm and the roller speed was 5 rpm). Then, for lamination of the electrode assembly, the Carver press was preheated to 330° C. A sandwich structure comprising the active layer and the backing layer (with the current collector attached) stacked between two aluminum foil sheets, was made as described in the previous examples. The sandwich structure was placed on the Carver press and subjected to 40 psi for 10 minutes. Afterward, the aluminum foil was removed and the electrode was characterized for weight and Gurley number (250). The Gurley number was evaluated with a Model 4240 instrument from Gurley Precision Instruments, Troy, N.Y.

### Example 4

Fuel Cell Electrodes Formed with a Blend of PTFE Particle Sizes

This example relates to the formation of fuel cell electrodes using a blend of PTFE particles with micron sized particles (PTFE T-60) and submicron/nanometer sized particles (PTFE T-30).

The method of this example was similar to that of example 1, however the active layer of this example was formed from a mixture of a Teflon emulsion (T30) with nanometer sized particles and PTFE T60 micron sized particles.

To prepare the active layer, 1.68 g of PTFE T60 (Dupont), 5.05 g of ABC-55 carbon black (Chevron Chemical Company) and 5.05 g of Pt-10 on Vulcan XC-72 catalyst (Johnson Matthey ) were mixed in a beaker at 25±2° C. The resulting mixture was gently stirred, and added in two portions to a 250 ml pulverizer. After pulverizing, the powders were blended at low speed for 15 seconds, medium speed for 15 seconds, and high speed for 150 seconds.

In a separate beaker, 8.42 g of T-30 PTFE emulsion (Dupont) was gently added to 41.3 g of 0.5% Triton X-100 aqueous solution while swirling the solution. With manual stirring, the powder formed in the previous paragraph was gradually added to this solution to form a dough. The dough was placed in a 1 L industrial Waring® blender and blended at high speed for 60 seconds. Consolidation of dough was achieved by hand working the dough (e.g. hand squeezed the dough twenty-five times).

For roll mixing, the roll mill rollers were preheated to 90° C., the nip was set to 205, and the roller speed was set to 5 rpm. The dough balls were then each subjected to a total of 10 mixing passes. The 10 mixing passes comprised first passing the dough ball through the mill 1 time, then passing 9 cigars, rotating the film 90° between each cigar pass, which are described above.

Adjusting the roll mill speed to 10 rpm and maintaining a roller temperature of 90° C., the active layers were then calendered. Calendering consisted of 11 passes at 9 different nip/gap settings. The nip/gap settings were the following (in mm): 3.93, 3.39, 2.82, 2.38, 2.14, 1.89, 1.89, 1.55, 1.55, 0.83, and 0.35. Care was taken to calender in the same direction. After the last pass, the calendered sheet was placed in a vacuum oven at a pressure of 30 inches of Hg and dried for 2 hours at 170° C. The sheet was cooled in the oven while bleeding in nitrogen gas. The active layer sheet was then trimmed to form a 7 cm×4.6 cm rectangle for electrode assembly.

The backing layer was prepared by mixing 50 g of PTFE-T60 (Dupont) and 50 g of ABC-55 carbon black (Chevron Chemical Company) in a beaker at 25±2° C. The resulting powder was then blended at low speed for 15 seconds, medium speed for 15 seconds and high speed for 90 seconds in a 4 liter Waring® heavy duty laboratory blender. A 7.5 g quantity of the blended powder was combined with 22.5 g of 1.5 weight percent Triton X-100 aqueous solution in a beaker. The mix was then stirred until the powder began to coagulate. The coagulated dough was then removed and hand worked into a dough ball. A standard Ziploc bag was used for storing the dough balls.

Each backing layer dough ball was then roll mixed in a manner similar to the active layer, as described above, except the backing layer was subjected to only 9 total mixing passes. On the first pass, the dough ball was simply passed through the mill, but for the next 8 passes the film was rotated 90° between each pass.

For calendering the backing layers, the roller temperature was left at 90° C., but the roller speed was set to 10 rpm. Calendering consisted of 10 passes at 8 different nip/gap settings. The nip/gap settings were the following (in mm) 3.93, 3.39, 2.82, 2.38, 1.89, 1.89, 1.55, 1.55, 0.83, 0.35 At gaps 1.89 mm and 1.55 mm, the film was rotated 180 degrees. Care was taken to calender in the same direction. After the last pass, the calendered sheet was placed in a vacuum oven at 30 inch Hg and dried for 2 hours at 170° C. The sheet was cooled in the oven while bleeding in nitrogen gas. The backing layer sheet was then trimmed to form a 7 cm×4.6 cm rectangle for electrode assembly.

To assemble the electrode of this example, the backing layer was first co-calendered to the current collector. Prior to co-calendering, a sandwich structure was created consisting, from bottom to top, of a 0.11 mm thick piece of wax paper, an 0.08 mm thick piece of Aluminum foil, the backing layer, and a piece of Ni-metal mesh. The sandwich structure was then passed through the roll mill (calender parameters: roller temperature of 100° C., 0.45 mm gap, and roll speed of 0.75 rpm). The aluminum foil and wax paper were removed. If the current collector was not adhered to the backing layer at this point, the co-calendering process was simply repeated.

A laminating procedure was used to complete the electrode assembly. The active layer sheet and backing layer sheet (with the current collector adhered) were cleaned using compressed air. Graphite release agent was sprayed on 1 side of 2 sheets of thick aluminum foil. The backing layer was placed on the aluminum foil, with the current collector resting against the aluminum foil. The active layer was placed on the backing layer, and the second aluminum foil sheet was placed on top of the active layer with the graphite-covered side facing out. This sandwich was placed on a Carver Laboratory Press model 4128 (Carver, Inc.) which had been preheated to 330° C., and pressed at 80 psi for 10 minutes. Before removing the aluminum foil, the electrode assembly was cooled.

The properties of the electrode prepared according to the forgoing method are listed in Table 4. In particular, Table 4 shows the thickness and corresponding Gurley number of various cathodes prepared using this method. The Gurley number was evaluated with a Model 4240 instrument from Gurley Precision Instruments, Troy, N.Y.

Table 4 also shows the performance of the electrodes prepared by this method when incorporated into a zinc-air fuel cell. In this particular example, the electrodes were tested as cathodes within a zinc-air fuel cell. Each cathode was tested for a set number of hours using a 35% KOH electrolyte. Shown in Table 2 are the corresponding average voltages for each cathode over a given time duration.

TABLE 4
Properties of electrodes and performance of corresponding
fuel cells of example 4

| | | Thickness | | Test | |
|---|---|---|---|---|---|
| Cathode | GN | (mm) | Electrolyte | hours | Voltage |
| 126E-d | 152 | 0.77 | 35% KOH | 96 | 0.91 |
| 126E-6 | 168 | 0.74 | 35% KOH | 624 | 1.0 |

### Example 5

Fuel Cell Cathode Formed with Graphite Friction Reducing Agent

In this example, a fuel cell is formed with a cathode including graphite as a friction reducing agent.

The method for preparing the electrode assembly in this example was similar to that of example 1, however this method also used graphite and produced a smaller cathode. Furthermore, the process comprised a rough and fine calendering step.

To prepare the active layer, 23.3 g of PTFE T60 (Dupont), 41.7 g of ABC-55 carbon black (Chevron Chemical Company), 30 g of Pt-10 on Vulcan XC-72 catalyst (Johnson Matthey), and 5 g of Graphite 5535 (Superior Graphite Co.) were mixed in a beaker at 25±2° C. The resulting powder was then blended at low speed for 15 seconds, medium speed for 15 seconds and high speed for 90 seconds in a 4-liter industrial blender. A 45 g quantity of the blended powder was combined with 105 g of 2 weight percent Tergitol® TMN-10 aqueous solution in a beaker. To prepare the 2 weight percent TMN-10 solution, 20 g of TMN-10 was diluted with deionized water in a 1000 mL volumetric flask. The mix was then stirred until the powder began to coagulate. The coagulated dough was then removed and hand worked into a dough ball. The dough ball was stored in a polypropylene jar with a screw cap in an oven for 30 minutes at 45° C. until ready to roll mill.

For roll mixing, the rollers were preheated to 71.1° C., the nip was set to 330, and the roller speed was set to 1.7 rpm. A mixing paddle tool was also installed. The dough balls were then each subjected to a total of 6 mixing passes. The 6 mixing passes comprised first passing 2 dough balls through the mill, then passing 2 cigars in the rolling direction (i.e. the 0° direction), followed by 2 cigars in the opposite direction (i.e. the film was rotated 90° on the last pass).

Before performing the rough calendering step, the mixing paddle tool was removed. The active layer film was then rotated 90° from its last mixing pass through the roll mill. The roll mill temperature and speed remained unchanged, and the active layer film was subjected to 9 passes at the nip/gap settings shown below in Table 5. Care was taken to calender in the same direction.

TABLE 5
Gap settings for rough calendering

| | Gap | Speed |
|---|---|---|
| Nip | (mm) | (rpm) |
| 330 | 6 | 1.7 |
| 305 | 5.5 | 1.7 |
| 270 | 4.5 | 1.7 |
| 245 | 3.93 | 1.7 |
| 215 | 3.39 | 1.7 |
| 190 | 2.82 | 1.7 |
| 165 | 2.38 | 1.7 |
| 100 | 2.00 | 1.7 |
| 17 | 1.65 | 1.7 |

After the 9 rough calendering passes, the active layer film was rotated 90° and subjected to 2 fine calendering passes. The gap settings of the 2 passes are shown below in Table 6. The calendered films were then placed in a vacuum oven at 30 inches of Hg and dried for 20 minutes at 120° C. After drying, the films were cooled in the oven while bleeding with Nitrogen gas. And after the film was inspected for pinholes, the active layer was cut to form a 256 mm×310 mm rectangle using a rough die-cut.

TABLE 6
Gap settings for fine calendering.

| | Gap | Speed |
|---|---|---|
| Nip | (mm) | (rpm) |
| 1 | 0.838 | 1.7 |
| 2 | 0.32 | 1.7 |

The backing layer was prepared by mixing 50 g of PTFE T60 (Dupont) and 50 g of ABC-55 carbon black (Chevron Chemical Company) in a beaker at 25±2° C. The resulting powder was then blended at low speed for 15 seconds, medium speed for 15 seconds and high speed for 90 seconds in a 4-liter blender. A 66 g quantity of the blended powder was combined with 95 g of 2 weight percent TMN- 10 aqueous solution in a beaker. The mix was then stirred until the powder began to coagulate. The coagulated dough was then removed and hand worked into a dough ball. The dough balls were then placed in a polypropylene jar with a screw cap in an oven for 30 minutes at 45° until ready to mill.

The roll mixing was performed in a manner similar to the roll mixing of the active layer. However, the rollers were preheated to a temperature of 80° C. and only 4 mixing passes were performed. The first pass was of the dough ball through the mill. Then 2 cigar passes in the rolling direction (i.e. 0° direction), followed by 1 cigar pass after rotating 90°.

The rough and fine calendering of the backing layer film was performed in the same manner as for the active layer, except that for the backing layers, the rollers were preheated to 80° C. The calendered backing layer films were then placed in a vacuum oven at 30 inch Hg and dried for 20 minutes at 145° C. After drying, the films were quickly removed and cooled on a table. And after the film was inspected for pinholes, the backing layer was cut to form a 256 mm×310 mm rectangle using a rough die-cut.

The electrode was assembled in a familiar manner. First, the Ni-mesh current collector was co-calendered to the backing layer film. This was done by stacking (from bottom to top) 0.11 mm wax paper, 0.08 mm aluminum foil, the backing layer film, and Ni mesh, and then passing this sandwich through a roll mill set at 100° C. with a gap of 0.45 mm, and a rotation speed of 0.75 rpm. The aluminum foil and wax paper were removed, and after ensuring sufficient adhesion between the backing layer and the current collector, a rough die-cut was made to fashion a 256 mm×310 mm backing layer (with current collector) film.

A laminating procedure was used to complete the electrode assembly. The active layer sheet and backing layer sheet (with the current collector adhered) were cleaned using compressed air. The backing layer was placed on the aluminum foil, with the current collector resting against the aluminum foil. The active layer was then placed on the backing layer, and the second aluminum foil sheet was placed on top of the active layer. The aluminum foil was sealed on three sides using a roller hand-tool. This sandwich structure was placed on the Carver Press described above, which had been preheated to 354° C., and pressed at 4000 lbs. for 10 minutes. Before removing the aluminum foil, the cathode assembly was cooled to 40° C.

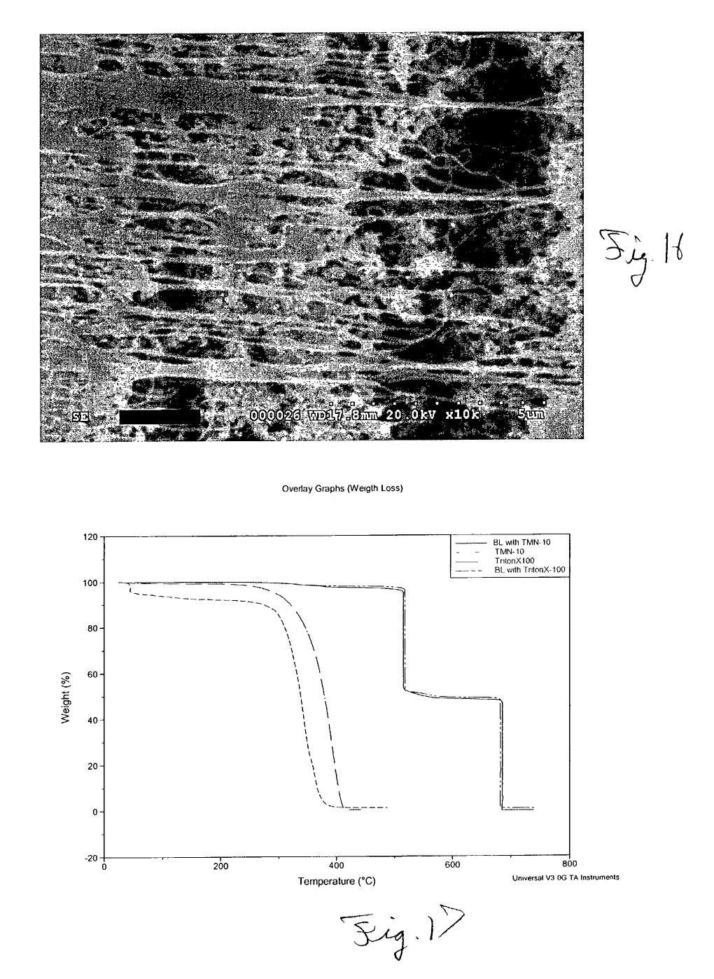

The properties of the electrode prepared according to the forgoing method are listed in Table 7. In particular, Table 2 shows the thickness and corresponding Gurley number of a cathode prepared using this method. The Gurley number was evaluated with a Model 4240 instrument from Gurley Precision Instruments, Troy, N.Y. Additionally, FIG. 14 shows the scanning electron micrograph (SEM) of a cross section of the cathode prepared by this method. The SEM demonstrates the coherence between the active layer and the backing layer of the cathode. FIGS. 15 and 16 provide higher magnification SEM of the active layer and backing layer cross sections, respectively. Thermogravimetric analysis was also performed on the active layer, backing layer and cathode to confirm that no surfactant remained (see FIG. 17).

Table 7 also shows the performance of the electrode prepared by this method when incorporated into a zinc-air fuel cell. In this particular example, the electrodes were tested as cathodes within a zinc-air fuel cell. Each cathode was tested for a set number of hours using a 35% KOH electrolyte. The average voltages over 240 hours are shown in Table 7.

TABLE 7
Properties of electrodes and and performance of corresponding
fuel cells from example 5.

| | | Thickness | | Test | Voltage |
|---|---|---|---|---|---|
| Cathode | GN | (mm) | Electrolyte | hours | (V) |
| 129G-9 | 185 | 0.84 | 45 wt % KOH + | 240 | 1.05 |
| | | | 2 wt % Na silicate | | |

As utilized herein, the term “in the range(s)” or “between” comprises the range defined by the values listed after the term “in the range(s)” or “between”, as well as any and all subranges contained within such range, where each such subrange is defined as having as a first endpoint any value in such range, and as a second endpoint any value in such range that is greater than the first endpoint and that is in such range.

The embodiments above are intended to be illustrative and not limiting. Additional embodiments are within the claims. Although the present invention has been described with reference to particular embodiments, workers skilled in the art will recognize that changes may be made in form and detail without departing from the spirit and scope of the invention.

What is claimed is:

1. An electrode composition comprising a fibrillatable polymer, a particulate electrical conductor, a surfactant and a liquid.

2. The electrode composition of claim 1 further comprising a catalyst.

3. The electrode composition of claim 2 wherein the catalyst comprises a noble metal.

4. The electrode composition of claim 2 wherein the catalyst comprises a metal oxide or a metal nitride.

5. The electrode composition of claim 2 wherein the catalyst comprises Fe, Co, Ru, Mn, Zn, Mo, Cr, Cu, V, Ni, Rh or a combination thereof.

6. The electrode composition of claim 2 wherein the catalyst comprises from about 80 weight percent to about 99.9 weight percent carbon black and from about 0.1 weight percent to about 20.0 weight percent metal.

7. The electrode composition of claim 6 wherein the catalyst further comprises about 0.05 weight percent to about 5.0 weight percent nitrogen.

8. The electrode composition of claim 1 further comprising a friction reducing agent.

9. The electrode composition of claim 8 wherein the friction reducing agent comprises graphite.

10. The electrode composition of claim 8 wherein the friction reducing agent is selected from the group consisting of molybdenum disulphide, boron nitride, cadmium iodide, antimony thioantimonate, Sb₂O₃, amino phosphates and mixtures thereof.

11. The electrode composition of claim 1 wherein the fibrillatable polymer comprises polytetrafluoroethylene.

12. The electrode composition of claim 1 wherein the fibrillatable polymer comprises a copolymer.

13. The electrode composition of claim 1 further comprising a second polymer.

14. The electrode composition of claim 1 wherein the particulate electrical conductor comprises carbon, elemental metal or mixtures thereof.

15. The electrode composition of claim 1 wherein the solids comprise at least about 20 weight percent electrically conductive particulates.

16. The electrode composition of claim 1 wherein the surfactant comprises a non-ionic surfactant.

17. The electrode composition of claim 1 wherein the surfactant comprises a polyoxyethylenated alkyl phenol, a polyoxyethylene alcohol or a mixture thereof.

18. The electrode composition of claim 1 wherein the surfactant concentration in the liquid is no more than about 4 weight percent of the liquid.

19. The electrode composition of claim 1 wherein the liquid comprises water.

20. The electrode composition of claim 19 wherein the composition comprises at least about 20 weight percent liquid.

21. A method for forming an electrode, the method comprising calendering an electrode composition comprising a fibrillatable polymer, a particulate electrical conductor, a liquid and a surfactant to form an electrode sheet.

22. The method of claim 21 wherein the calendering is performed at a temperature from about 30° C. to about 80° C.

23. The method of claim 21 wherein the calendering is performed with rollers.

24. The method of claim 21 wherein the calendering is performed with a pair of opposing belts.

25. The method of claim 21 further comprising extruding the electrode composition to form an extrudate prior to calendering the extrudate.

26. The method of claim 25 wherein the extruding is performed with a ram extruder.

27. The method of claim 21 wherein the calendering comprises multiple passes through a calendering apparatus.

28. The method of claim 27 wherein the calendering is performed with multiple pairs of opposing rollers sequentially aligned.

29. The method of claim 21 further comprising drying the electrode sheet to form a dried film having no more than about 5 weight percent liquid.

30. The method of claim 29 wherein the dried film is gas permeable.

31. The method of claim 21 wherein the fibrillatable polymer comprises polytetrafluoroethylene.

32. The method of claim 21 wherein the cathode composition further comprises a friction reducing agent.

33. The method of claim 21 wherein the electrode composition further comprises a catalyst.

34. The method of claim 21 further comprising attaching a current collector to the cathode composition.

35. The method of claim 34 wherein the attaching the current collector to the cathode composition is performed following drying the cathode composition to form a dried film having no more than about 20 weight percent water.

36. The method of claim 34 wherein the attaching the current collector to the electrode composition comprises calendering the current collector and the electrode composition together prior to drying the cathode composition.

37. The method of claim 21 wherein the electrode composition comprises a catalyst and wherein the method further comprises attaching the electrode sheet to an electrode backing layer.

38. The method of claim 21 wherein the electrode composition comprises a catalyst and wherein the method further comprises co-calendering the electrode sheet, an electrode backing layer and a current collector, the electrode backing layer being substantially free of catalyst.

39. A method for forming an energy cell, the method comprising assembling a cell structure comprising a cathode, an anode and a separator between the cathode and the anode, wherein the cathode is formed using the method of claim 28.

40. The method of claim 39 wherein the energy cell comprises a plurality of cathodes and a plurality of anodes.

41. The method of claim 39 wherein the energy cell is a metal-gas fuel cell.

42. The method of claim 41 wherein the anode comprises elemental zinc or an alloy thereof.

43. A gas permeable electrode film comprising a fibrillatable polymer and at least about 20 weight percent electrically conductive particles, the film having a width of at least about 6 centimeters and a thickness less than about 5 mm and a uniformity of thickness over the width of the film that varies by less than about 30% from the average.

44. A gas permeable electrode comprising a fibrillatable polymer, a particulate electrical conductor, and a non-carbon friction reducing agent within a gas permeable structure.

45. A method for forming an electrode, the method comprising molding an electrode composition within a mold, the electrode composition comprising a polymer, electrically conductive particulates, a carrier fluid and a pore forming agent.

46. The method of claim 45 wherein the electrode composition further comprises a catalyst.

47. The method of claim 45 wherein the electrode composition further comprises a surfactant.

48. The method of claim 45 wherein the mold is under vacuum when the electrode composition is placed within the mold.

49. The method of claim 45 wherein the electrode composition is placed within the mold and evacuated at a pressure lower than atmospheric pressure.

50. The method of claim 45 wherein the mold is heated during the molding process.
